(19) United States
(12) Patent Application Publication
(10) Pub. No.: US 2024/0171484 A1
(43) Pub. Date: May 23, 2024

(54) Methods and Apparatuses for Providing an Analytic Result Relating to Tunneling Traffic to a Consumer Network Function

(71) Applicant: Telefonaktiebolaget LM Ericsson (publ), Stockholm (SE)

(72) Inventor: Miguel Angel Muñoz De La Torre Alonso, Madrid (ES)

(21) Appl. No.: 18/283,690

(22) PCT Filed: Aug. 17, 2021
(86) PCT No.: PCT/EP2021/072856

§ 371 Date: Sep. 22, 2023

(30) Foreign Application Priority Data
Mar. 25, 2021 (EP) 21382246.3

(51) Int. Cl. H04L 43/062; H04L 41/22; H04L 43/026

(52) U.S. Cl. CPC H04L 43/062; H04L 41/22; H04L 43/026

(57) ABSTRACT

Embodiments described herein relate to methods and apparatuses for providing an analytic result relating to tunneling traffic to a consumer network function, NF. A method in a first network function comprises receiving a request from the consumer NF, to receive analytics relating to tunneling traffic; responsive to receiving the request, triggering one or more network nodes to transmit data relating to tunneling traffic to the first NF; receiving data relating to tunneling traffic from one or more network nodes; analysing the received data to determine an analytic result; and transmitting an indication of the analytic result to the consumer NF.

### TECHNICAL FIELD

Embodiments described herein relate to methods and apparatuses to provide new type of analytic relative to tunneling traffic.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

FIG. 1 illustrates a 5G reference architecture as defined by 3GPP.

Some of the relevant architectural aspects for this disclosure are: the NWDAF (Network Data Analytics Function), the UDR (Unified Data Repository), the PCF (Policy Control Function), the SMF (Session Management Function), and the UPF (User Plane Function).

The NWDAF represents an operator managed network analytics logical function. The NWDAF is part of the 5GC architecture and uses the mechanisms and interfaces specified for 5GC and operations administration and management (OAM). The NWDAF interacts with different entities for different purposes. For example:
Data collection (for example, based on event subscription). The data may be, for example, provided by Access and Mobility Management Function (AMF), SMF, PCF, Unified data management (UDM), Application Function (AF) (directly or via the Network Exposure Function (NEF)), and Operations, Administration and Maintenance (OAM);
Retrieval of information from data repositories (e.g. UDR via UDM for subscriber-related information);
Retrieval of information about NFs (e.g. Network Repository Function (NRF) for NF-related information, and Network Slice Selection Function (NSSF) for slice-related information);
On demand provision of analytics to consumers.

The Unified Data Repository (UDR) stores data grouped into distinct collections of subscription-related information:
Subscription Data;
Policy Data;
Structured Data for Exposure;
Application Data.

The Policy Control Function (PCF) supports a unified policy framework to govern the network behavior. Specifically, the PCF provides PCC (Policy and Charging Control) rules to the PCEF (Policy and Charging Enforcement Function), i.e. the SMF/UPF that enforces policy and charging decisions according to provisioned PCC rules.

The Session Management function (SMF) supports different functionalities, e.g. the SMF may receive PCC rules from the PCF and configures the UPF accordingly.

The User Plane function (UPF) supports handling of user plane traffic based on the rules received from the SMF, e.g. packet inspection and different enforcement actions such as Quality of Service (QoS) handling.

In computer networks, a tunneling protocol is a communications protocol that allows for the movement of data from one network to another. It involves allowing private network communications to be sent across a public network (such as the Internet) through a process called encapsulation.

Tunneling is the idea of carrying lower-layer traffic in higher-layer (or equal-layer) packets. For example, IPv4 can be carried in an IPv4 or IPv6 packet; Ethernet can be carried in a User Datagram Protocol (UDP) or IPv4 or IPv6 packet, and so on.

In other words, tunneling is achieved by injecting packets into the payload of other packets.

Various protocols for establishing tunnels exist, e.g. Generic Routing Encapsulation (GRE) or the Layer 2 Tunneling Protocol (L2TP).

The result is that virtual links between computers in different networks may be set up. An example of this is a company's private network, which may be reached from the public network via tunneling.

Because tunneling involves repackaging the traffic data into a different form, it may hide the nature of the traffic that is run through a tunnel.

Users may also use tunneling to “sneak through” a firewall, using a protocol that the firewall would normally block, but “wrapped” inside a protocol that the firewall does not block, such as Domain Name System (DNS).

Types of tunneling techniques and protocols:
DNS tunneling
Internet Control Message Protocol (ICMP) tunneling
Internet Protocol (IP) in IP (Protocol 4): IP in IPv4/IPv6
SIT/IPv6 (Protocol 41): IPv6 in IPv4/IPv6
Generic Routing Encapsulation (GRE) (Protocol 47):
Open virtual private network (OpenVPN) (UDP port 1194)
Secure Socket Tunneling Protocol (SSTP) (TCP port 443):
Internet Protocol Security (IPSec) (Protocol 50 and 51):
Layer 2 Tunneling Protocol (L2TP) (Protocol 115): Layer 2 Tunneling Protocol
Virtual Extensible Local Area Network (VXLAN) (UDP port 4789):
Secure Shell (SSH) tunneling
Hypertext Transfer Protocol (HTTP)/Hypertext Transfer Protocol Secure (HTTPS)/Secure Sockets Layer (SSL) tunneling (HTTP CONNECT)
QUIC tunneling (CONNECT-UDP)

DNS tunneling is a difficult to detect attack that encodes the data of other programs or protocols in DNS queries and responses, by creating a covert communication channel that bypasses most firewalls. DNS tunneling enables cybercriminals to insert malware or pass stolen information into DNS queries. DNS requests are routed to the attacker's server, providing them with a covert command and control channel, and a data exfiltration path. DNS tunneling is also a technique use for fraud, as DNS traffic is usually free rated.

As an example, a user downloaded malware or an attacker exploited a vulnerability to deliver a malicious payload. If the attacker wants to maintain contact with the compromised device (to run commands on the victim device or exfiltrate data), they can establish a command-and-control (C&C) connection. C&C traffic may be required to pass through network perimeter defenses and evade detection while crossing the network.

DNS is a good candidate for establishing a tunnel, which is a cybersecurity term for a protocol connection that encapsulates a payload that contains data or commands and passes through perimeter defenses. Essentially, DNS tunneling hides data within DNS queries that are sent to an attacker-controlled server. DNS traffic is generally allowed to pass through perimeter defenses, such as firewalls, that typically block inbound and outbound malicious traffic.

To establish a DNS tunnel, the attacker registers a domain (adomain.com) and sets up a C&C server as the authoritative name server for adomain.com. The malware or payload on the compromised device sends a DNS query for a subdomain that represents an encoded communication (base64encodeddata.adomain.com). The query is eventually routed by a DNS resolver (through root and top-level domain servers) to the C&C server. The C&C server then sends a malicious DNS response that includes data (such as a command) to the compromised device, passing undetected through the perimeter. Over time, the attacker can continue C&C activity or exfiltrate data through the DNS tunnel.

An ICMP tunnel establishes a covert connection between two remote computers (a client and proxy), using ICMP echo requests and reply packets. An example of this technique is tunneling complete Transmission Control Protocol (TCP) traffic over ping requests and replies.

A virtual private network (VPN) extends a private network across a public network and enables users to send and receive data across shared or public networks as if their computing devices were directly connected to the private network. Applications running across a VPN may therefore benefit from the functionality, security, and management of the private network.

VPN systems may be classified by:
the tunneling protocol used to tunnel the traffic
the tunnel's termination point location, e.g., on the customer edge or network-provider edge
the type of topology of connections, such as site-to-site or network-to-network
the levels of security provided
the Open Systems Interconnection (OSI) layer they present to the connecting network, such as Layer 2 circuits or Layer 3 network connectivity
the number of simultaneous connections

Tunnels are typically established through virtual private network (VPN) technologies. Once a VPN tunnel has been established between a teleworker's client device and the organization's VPN gateway, the teleworker can access many of the organization's computing resources through the tunnel.

The types of VPNs most commonly used for teleworkers are Internet Protocol Security (IPsec) and Secure Sockets Layer (SSL) tunnels. Tunneling may also be achieved by using Secure Shell (SSH), although this is less commonly used.

A mobile virtual private network (mobile VPN or mVPN) is a VPN which is capable of persisting during sessions across changes in physical connectivity, point of network attachment, and IP address. The “mobile” in the name refers to the fact that the VPN can change points of network attachment, not necessarily that the mVPN client is a mobile phone or that it is running on a wireless network.

Mobile VPNs are used in environments where workers need to keep application sessions open at all times, throughout the working day, as they connect via various wireless networks, encounter gaps in coverage, or suspend-and-resume their devices to preserve battery life. A conventional VPN may not be able to survive such events because the network tunnel is disrupted, causing applications to disconnect, time out, fail, or even the computing device itself to crash. Mobile VPNs are commonly used in public safety, home care, hospital settings, field service management, utilities and other industries. Increasingly, they are being adopted by mobile professionals and white-collar workers

Users utilize mobile virtual private networks (mobile VPN or mVPN) in settings where an endpoint of the VPN is not fixed to a single IP address, but instead roams across various networks such as data networks from cellular carriers or between multiple Wi-Fi access points without dropping the secure VPN session or losing application sessions. Mobile VPNs are widely used in public safety where they give law-enforcement officers access to applications such as computer-assisted dispatch and criminal databases, and in other organizations with similar requirements such as Field service management and healthcare.

Machine learning (ML) is the study of computer algorithms that improve automatically through experience. It is seen as a part of artificial intelligence. Machine learning algorithms build a model based on sample data, known as “training data”, in order to make predictions or decisions without being explicitly programmed to do so. Machine learning algorithms are used in a wide variety of applications, such as email filtering and computer vision, where it is difficult or unfeasible to develop conventional algorithms to perform the needed tasks.

There are 3 primary types of Machine Learning Algorithms:
Supervised Learning
This algorithm consists of a target/outcome variable (or dependent variable) which is to be predicted from a given set of predictors (independent variables). Using these set of variables, a function may be generated that maps inputs to desired outputs. The training process continues until the model achieves a desired level of accuracy on the training data. Examples of Supervised Learning: Regression, Decision Tree, Random Forest, k-nearest neighbors (KNN), Logistic Regression etc.
Unsupervised Learning
In this algorithm, there is not have any target or outcome variable to predict/estimate. This algorithm is used for clustering population in different groups, which is widely used for segmenting customers in different groups for specific intervention. Examples of Unsupervised Learning: Apriori algorithm, K-means.
Reinforcement Learning:
Using this algorithm, the machine is trained to make specific decisions. For example, the machine is exposed to an environment where it trains itself continually using trial and error. This machine learns from past experience and tries to capture the best possible knowledge to make accurate business decisions. Example of Reinforcement Learning: Markov Decision Process.

### SUMMARY

According to some embodiments there is provided a method in a first network function, NF, in a network for providing, to a consumer NF, an analytic result relating to tunneling traffic. The method comprises receiving a request from the consumer NF, to receive analytics relating to tunneling traffic; responsive to receiving the request, triggering one or more network nodes to transmit data relating to tunneling traffic to the first NF; receiving data relating to tunneling traffic from one or more network nodes; analysing the received data to determine an analytic result; and transmitting an indication of the analytic result to the consumer NF.

According to some embodiments there is provided a method, in a consumer network function for receiving an analytic result relating to tunneling traffic from a first network function, NF. The method comprises transmitting a request to the first NF, to receive analytics relating to tunneling traffic; and receiving an indication of the analytic result from the first NF.

According to some embodiments there is provided a method in a User Plane Function, UPF, for providing data relating to tunneling traffic to a first network function, NF. The method comprises receiving a request from the first NF, to receive data relating to tunneling traffic; and responsive to detecting the tunneling traffic, providing data relating to the tunneling traffic to the first NF.

According to some embodiments there is provided a method in a wireless device, for providing data relating to tunneling traffic to a first network function, NF. The method comprises receiving a request from the first NF, wherein the request subscribes to receiving data relating to tunneling traffic; and responsive to detecting tunneling traffic, providing data relating to the tunneling traffic to the first NF.

According to some embodiments there is provided a method in a User Data Repository, UDR, for providing data relating to tunneling traffic to a first network function, NF. The method comprises receiving a request from the first NF, for data relating to tunneling traffic, wherein the request comprises an indication of at least one wireless device identification; and providing tunneling related subscriber data associated with the at least one wireless device identification to the first NF.

According to some embodiments there is provided a method in a first network function, NF, for training a ML model. The method comprises transmitting a request to a second network function and/or a wireless device to receive tagged data relating to tunneling traffic where the tagged data is tagged with a tag indicating a type of the tunneling traffic; receiving the tagged data relating to tunneling traffic from the second network function and/or the wireless device; and training the ML model based on the tagged data.

According to some embodiments there is provided a first network function, NF, in a network for providing, to a consumer NF, an analytic result relating to tunneling traffic. The first NF comprises processing circuitry configured to: receive a request from the consumer NF, to receive analytics relating to tunneling traffic; responsive to receiving the request, trigger one or more network nodes to transmit data relating to tunneling traffic to the first NF; receive data relating to tunneling traffic from one or more network nodes; analyse the received data to determine an analytic result; and transmit an indication of the analytic result to the consumer NF.

According to some embodiments there is provided a consumer network function for receiving an analytic result relating to tunneling traffic from a first network function, NF. The consumer network function comprises processing circuitry configured to: transmit a request to the first NF, to receive analytics relating to tunneling traffic; and receive an indication of the analytic result from the first NF.

According to some embodiments there is provided a User Plane Function, UPF, for providing data relating to tunneling traffic to a first network function, NF. The UPF comprises processing circuitry configured to: receive a request from the first NF, to receive data relating to tunneling traffic; and responsive to detecting the tunneling traffic, provide data relating to the tunneling traffic to the first NF.

According to some embodiments there is provided a wireless device, for providing data relating to tunneling traffic to a first network function, NF. The wireless device comprises processing circuitry configured to: receive a request from the first NF, wherein the request subscribes to receiving data relating to tunneling traffic; and responsive to detecting tunneling traffic, provide data relating to the tunneling traffic to the first NF.

According to some embodiments there is provided a User Data Repository, UDR, for providing data relating to tunneling traffic to a first network function, NF. The UDR comprises processing circuitry configured to: receive a request from the first NF, for data relating to tunneling traffic, wherein the request comprises an indication of at least one wireless device identification; and provide tunneling related subscriber data associated with the at least one wireless device identification to the first NF.

According to some embodiments there is provided first network function, NF, for training a ML model. The first NF comprises processing circuitry configured to: transmit a request to a second network function and/or a wireless device to receive tagged data relating to tunneling traffic where the tagged data is tagged with a tag indicating a type of the tunneling traffic; receive the tagged data relating to tunneling traffic from the second network function and/or the wireless device; and train the ML model based on the tagged data.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a 5G reference architecture as defined by 3GPP;

FIG. 2 illustrates a method in a first network function, NF, in a network for providing, to a consumer NF, an analytic result relating to tunneling traffic;

FIG. 3 illustrates a method in a consumer network function, NF, for receiving an analytic result relating to tunneling traffic from a first network function, NF;

FIG. 4 illustrates a method in a User Plane Function, UPF, for providing data relating to tunneling traffic to a first network function, NF;

FIG. 5 illustrates a method in a wireless device, for providing data relating to tunneling traffic to a first network function, NF;

FIG. 6 illustrates a method in a User Data Repository, UDR, for providing data relating to tunneling traffic to a first network function, NF;

FIG. 7a illustrates a method for training a ML model in a first NF, e.g. a NWDAF;

FIG. 7b is a sequence diagram illustrating an example implementation of the supervised ML model training process as described with reference to FIG. 7a;

FIG. 8 is a sequence diagram illustrating an example implementation of the methods of FIGS. 2 to 6;

FIG. 9 is a sequence diagram illustrating an example implementation of the methods of FIGS. 2 to 6;

FIG. 10 is a sequence diagram illustrating an example implementation of the method of FIGS. 2 to 6;

FIG. 11 illustrates a first network function (NF) comprising processing circuitry (or logic);

FIG. 12 illustrates a consumer network function (NF) comprising processing circuitry (or logic);

FIG. 13 illustrates a User Plane Function (UPF) comprising processing circuitry (or logic);

FIG. 14 illustrates a wireless device comprising processing circuitry (or logic);

FIG. 15 illustrates a UDR comprising processing circuitry (or logic).

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Tunneled traffic in mobile networks has increased significantly over the last years and is now becoming an important target for Mobile Network Operators (MNOs), which currently lack a proper mechanism to detect and control tunneled traffic. In addition to the above, and due to COVID-19, the number of mobile subscribers teleworking (using tunneled traffic through VPNs) has also increased significantly. Furthermore, traffic encryption trends make it more complex for a MNO to detect tunneled traffic.

Embodiments described herein propose methods and apparatuses that solve the above problems by utilizing a new type of analytic relative to tunneling traffic, which allows the mobile network operator (MNO) to detect tunneling (e.g. DNS tunneling, ICMP tunneling) and to act upon it.

One of the main objectives of a MNO is to control the traffic traversing MNO's network, specifically embodiments described herein, propose methods and apparatuses to perform statistical analysis on tunneling behavior, e.g. so as to improve MNO's data service contract and/or network performance.

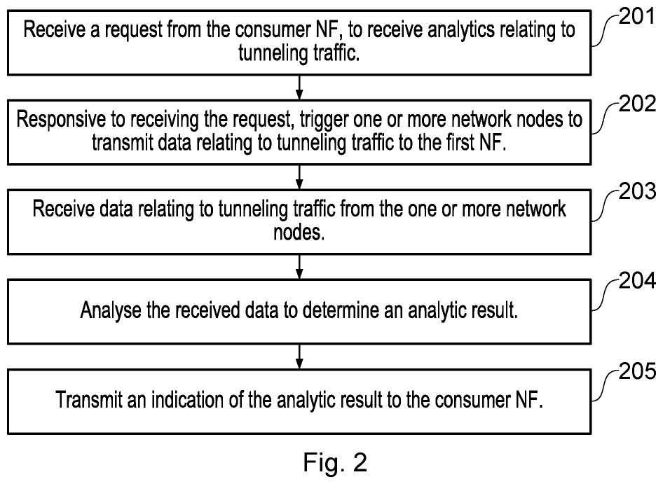

FIG. 2 illustrates a method in a first network function, NF, in a network for providing, to a consumer NF, an analytic result relating to tunneling traffic. The first NF may comprise a NWDAF.

In step 201 the method comprises receiving a request from the consumer NF, to receive analytics relating to tunneling traffic. The consumer NF may comprise any suitable NF, for example the PCF or OAM.

For example, the request may comprise a subscription request. The request may in some examples comprise one or more of: an indication of a tunneling traffic type, a list of one or more wireless device identifications, and an indication a tunneling scenario the first NF wishes to be alerted of.

For example, a tunneling traffic type may comprise one or more of: DNS, Internet Control Message Protocol (ICMP), Hypertext Transfer Protocol (HTTP), QUIC, Internet Protocol (IP) in IP, Generic Routing Encapsulation (GRE), Internet Protocol Security (IPSec), Layer 2 Tunneling Protocol (L2TP), Virtual Extensible LAN (VXLAN), Open Virtual Private Network (VPN), Secure Socket Tunneling Protocol (SSTP), Secure Shell (SSH), etc. The tunneling traffic type may indicate the specific tunneling protocol of interest for the consumer NF. When no specific tunneling traffic type is included in the request of step 201, the request may relate to tunneling analytics irrespective of the tunneling traffic type.

In step 202, the method comprises, responsive to receiving the request, triggering one or more network nodes to transmit data relating to tunneling traffic to the first NF.

The one or more network nodes may comprise one or more of: at least one user equipment, a User Plane Function, UPF, and a User Data Repository, UDR.

In step 203, the method comprises receiving data relating to tunneling traffic from the one or more network nodes.

In step 204, the method comprises analysing the received data to determine an analytic result. In some examples, step 204 may comprise performing statistical analysis of the received data. In some examples, step 204 may utilise a machine learning model to determine the analytic result.

The analytic result may comprise an indication of the tunneling traffic type. For example, the tunneling traffic type may comprise DNS, ICMP, HTTP, QUIC, IPinIP, GRE, IPSec, L2TP, VXLAN, OpenVPN, SSTP or SSH, etc.

The analytic result may comprise a list of wireless device identifications. The list of wireless device identifications may identify which wireless device IDs have been found to use tunneling (on a per tunneling protocol basis). Each wireless device ID may comprise a subscriber identifier (SUPI/IMSI), a subscriber public identifier (PUI/MSISDN) and/or a device identifier (PEI/IMEl).

The analytic result may comprise an indication of whether the tunneling traffic is considered normal or abnormal. For example, normal traffic may comprise a teleworker using a VPN tunnel towards his/her Enterprise, this is considered as normal behavior. However, when DNS protocol is used for tunneling traffic (e.g. DNS volume is much higher than normal), this may be considered abnormal behaviour. The indication of whether the tunneling traffic is considered normal or abnormal may be associated with a confidence level (e.g. a percentage from 0% to 100%).

The analytic result may in some examples comprise: an indication of a percentage of total traffic in the network that comprises tunneling traffic; an indication of a percentage of total traffic to and from a first wireless device that comprises tunneling traffic; and/or an indication of a percentage of total traffic that comprises tunneling traffic of a tunneling traffic type. This may be useful information, e.g. in case DNS tunneling is used for fraud, as DNS traffic is usually free of charge.

The analytic result may relate to the information contained in the request received in step 201. For example, if the request received in step 201 comprises an indication of a tunneling traffic type, then the analytic result may relate to tunneling traffic of the tunneling traffic type. Similarly, if the request received in step 201 comprises an indication of one or more wireless device identifications, the analytic result may relate to tunneling traffic to the one or more wireless devices identified by the one or more wireless device identifications. Similarly, if the request received in step 201 comprises an indication of a tunneling scenario (e.g. abnormal tunneling), then the analytic result may relate to tunneling traffic in said scenario.

In some examples, the analytic result comprises a list of one or more application identifications that are generating the tunneling traffic (e.g. App-ID=MyVPN).

In some examples, the analytic result may comprise one or more of: a list of one or more server addresses acting as tunnel endpoints for the tunneling traffic, and a list of one or more target domains for the tunneling traffic. The list of one or more target domains may Identify the target domain/s for the tunneling traffic, e.g. in case of HTTP tunneling, the domain included in the HTTP CONNECT request message; or in case of abnormal scenario with DNS tunneling, for a DNS query with QNAME including a subdomain that represents an encoded communication (base64encodeddata.adomain.com), the domain may be adomain.com.

In some examples, the analytic result comprises an indication of at least one recommended traffic management action.

For example, where the analytic result indicates that the tunneling traffic is abnormal the at least one recommended traffic management action may comprise one of: blocking tunneled traffic to one or more domains or server addresses, blocking tunneled traffic associated with one or more application identifications, and steering a copy of the tunneled traffic to an offline analytics engine.

For example, the recommended traffic action may be to block tunneled traffic to the suspect domains and/or Server addresses, or to block tunneled traffic for the suspect App-ID/s if the confidence level is high.

If the confidence level is medium the recommended traffic action may comprise traffic steering, for example, to steer a copy of the tunneled traffic towards an offline analytics engine.

In some examples, where the analytic result indicates that a majority of traffic to the first wireless device is tunneling traffic, and the recommended traffic management action comprises moving traffic of the first wireless device to a network slice suitable for tunneling traffic (e.g. from MBB slice into a VPN slice).

In some examples, the at least one recommended traffic management action comprises storing the analytic result as subscriber data at a user data repository. For example, for each suspect wireless device identification, an indication of the wireless device being a subscriber/device where tunneling has been detected and the corresponding tunneling information may be stored.

In step 205 the method comprises transmitting an indication of the analytic result to the consumer NF.

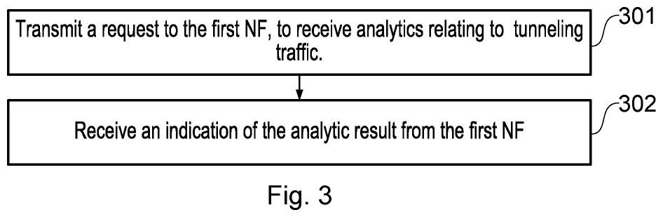

FIG. 3 illustrates a method in a consumer network function, NF, for receiving an analytic result relating to tunneling traffic from a first network function, NF. The first NF may comprise an NWDAF. The first NF may be configured to perform the method as described with reference to FIG. 2. The consumer NF may comprise any suitable NF, for example the PCF or OAM.

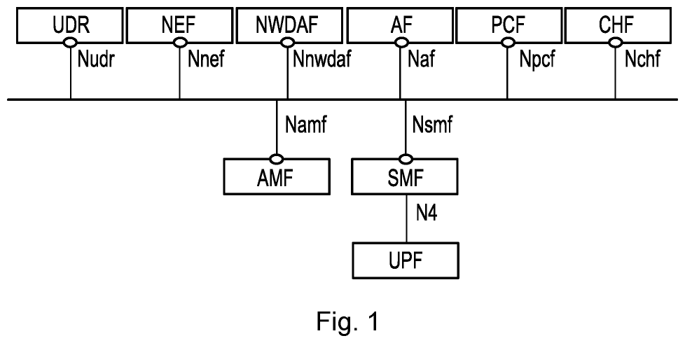

In step 301, the method comprises transmitting a request to the first NF, to receive analytics relating to tunneling traffic. Step 301 may correspond to step 201 of FIG. 1

For example, the request may comprise a subscription request. The request may in some examples comprise one or more of: an indication of a tunneling traffic type, a list of one or more wireless device identifications, and an indication a tunneling scenario the first NF wishes to be alerted of.

For example, a tunneling traffic type may comprise one or more of: DNS, ICMP, HTTP, QUIC, IPinIP, GRE, IPSec, L2TP, VXLAN, OpenVPN, SSTP, SSH, etc. The tunneling traffic type may indicate the specific tunneling protocol of interest for the consumer NF.

When no specific tunneling traffic type is included in the request of step 301, the request may relate to tunneling analytics irrespective of the tunneling traffic type.

In step 302, the method comprises receiving an indication of the analytic result from the first NF. Step 302 may correspond to step 205 of FIG. 2.

The analytic result may comprise any suitable information as described previously with reference to FIG. 2.

In some examples, the analytic result may comprise at least one recommended traffic management action. In these examples, the method of FIG. 3 may further comprise initiating performance of the at least one recommended traffic management action.

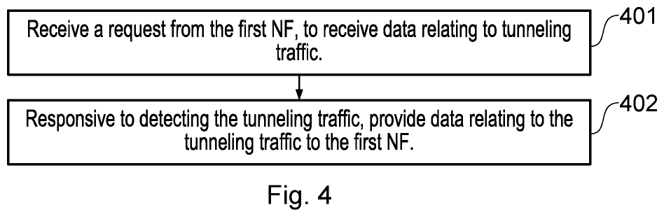

FIG. 4 illustrates a method in a User Plane Function, UPF, for providing data relating to tunneling traffic to a first network function, NF. The first NF may be configured to perform the method as described with reference to FIG. 2. The first NF may comprise an NWDAF.

In step 401, the method comprises receiving a request from the first NF, to receive data relating to tunneling traffic.

In step 402 the method comprises, responsive to detecting the tunneling traffic, providing data relating to the tunneling traffic to the first NF.

The request of step 401 may comprise an indication of a tunneling traffic type. In these examples, the detected tunneling traffic may therefore comprise tunneling traffic of the tunneling traffic type.

In some examples, the request of step 401 may comprise a list of one or more wireless device identifications. In these examples, the detected tunneling traffic may comprise tunneling traffic to or from a first wireless device identified by one of the one or more wireless devices identifications.

In some examples, the tunneling traffic comprises Domain Name System, DNS, tunneling traffic, and the data relating to the tunneling traffic comprises one or more of: a timestamp for a DNS query and/or a DNS answer, a volume of a DNS query and/or a DNS answer; a 5-tuple comprising a DNS server IP address; a DNS query type; a QNAME in DNS query type A/AAAA; a List of Server IP addresses in a DNS answer; raw Internet Protocol packets for the DNS tunneling traffic. It will be appreciated that other data may be provided.

In some examples, the tunneling traffic comprises Internet Protocol Security, IPSec, tunneling traffic, and the data relating to the tunneling traffic comprises one or more of: a timestamp for an IPSec event start time and/stop time; a volume of the IPSec tunneling traffic; an Internet Protocol, IP, Number associated with the IPSec tunneling traffic; an outer IP header source/destination IP address associated with the IPSec tunneling traffic; authentication header information; Encapsulating Security Payload header information. It will be appreciated that other data may be provided.

In some examples, the tunneling traffic comprises ICMP tunneling traffic (e.g. ICMP (IPv4) and ICMPv6), and the data relating to the tunneling traffic comprises one or more of: a timestamp for an ICMP flow start time and/or stop time; a 5-tuple a server IP address; a number of ICMP data packets in the flow; a volume of ICMP data packets in the flow (e.g. in bytes); a number of not usual Type (e.g. deprecated, experimental) data packets; a number of ICMP Echo Reply (Type 0) and Echo Request (Type 8) packets; a number of data packets with abnormal length; a number of data packets with abnormal content; a number of data packets with non-repetitive content; an average data packet length; a variance data packet length. It will be appreciated that other data may be provided.

In some examples, the tunneling traffic comprises HTTP or HTTPS tunneling traffic, and the data relating to the tunneling traffic comprises one or more of: for each detected HTTP/HTTPS flow: a timestamp for an HTTP/HTTPS flow start time and/or stop time; a TCP port (e.g. 80, 8080, 443); a volume (e.g. in bytes) of the HTTP/HTTPS flow; a 5-tuple comprising a HTTP/HTTPS server or proxy IP address; a number of HTTP CONNECT procedures; for each HTTP CONNECT message: a domain included in an HTTP CONNECT message; and/or for each successful response: a volume of traffic after an HTTP CONNECT procedure. It will be appreciated that other data may be provided.

In some examples, the tunneling traffic comprises QUIC tunneling traffic, and the data relating to the tunneling traffic comprises one or more of: for each detected QUIC flow: a timestamp for a QUIC flow start time and/or stop time; a UDP port (e.g. 80, 443); a volume (e.g. in bytes) of the QUIC flow; a 5-tuple comprising a QUIC server and/or proxy IP address; a number of CONNECT-UDP procedures; for each CONNECT-UDP message a domain included in CONNECT-UDP message; for each successful CONNECT-UDP response a volume of traffic after CONNECT-UDP procedure. It will be appreciated that other data may be provided.

In some examples, the tunneling traffic comprises IPinIP tunneling traffic, and the data relating to the tunneling traffic comprises one or more of: for each detected IPinIP flow: a timestamp fora IPinIP flow start time and/or stop time, a volume (e.g. in bytes) of the IPinIP flow; an outer IP header source/destination IP address; an inner IP header source/destination IP address; a type (e.g. IPv6 over IPv4, IPv4 over IPv4); and a protocol stack over IPinIP (e.g. TCP with TCP server port 80). It will be appreciated that other data may be provided.

In some examples, the tunneling traffic comprises GRE tunneling traffic, and the data relating to the tunneling traffic comprises one or more of: for each detected GRE flow: a timestamp for a GRE flow start time and/or stop time; a volume (e.g. in bytes) of the GRE flow; an IP Protocol Number (e.g. 47); an outer IP header source/destination IP address; and GRE encapsulated information (e.g. a network (e.g. IPv4/1Pv6, source/destination IP address); a transport (e.g. UDP/TCP, server port); and/or an upper protocol stack (e.g. TLS, QUIC, HTTP, and also other information like SNI)). It will be appreciated that other data may be provided.

In some examples, the tunneling traffic comprises L2TP tunneling traffic, and the data relating to the tunneling traffic comprises one or more of: for each detected L2TP flow: a timestamp for an L2TP flow start time and/or stop time; a volume (e.g. in bytes) of the L2TP flow; a transport port (e.g. 1701); an outer IP header source/destination IP address; an L2TP tunneling type (e.g. L2TP/IPsec); and L2TP packet information (e.g. Tunnel ID, Session ID). It will be appreciated that other data may be provided.

In some examples, the tunneling traffic comprises VXLAN tunneling traffic, and the data relating to the tunneling traffic comprises one or more of: for each detected VXLAN flow; a timestamp for a VXLAN flow start time and/or stop time; a volume (e.g. in bytes) of the VXLAN flow; a 5-tuple comprising a server IP address and UDP port (e.g. 4789); and VXLAN parameters (e.g. VNI or VXLAN Network Identifier). It will be appreciated that other data may be provided.

In some examples, the tunneling traffic comprises Open VPN tunneling traffic, and the data relating to the tunneling traffic comprises one or more of: for each detected

OpenVPN flow: a timestamp for an OpenVPN flow start time and/or stop time; a volume (e.g. in bytes) of the OpenVPN flow; a 5-tuple comprising a server IP address and a TCP port 1194. It will be appreciated that other data may be provided.

In some examples, the tunneling traffic comprises SSTP tunneling traffic, and the data relating to the tunneling traffic comprises one or more of: for each detected SSTP flow: a timestamp for a SSTP flow start time and/or stop time; a volume (e.g. in bytes) of the SSTP flow; a 5-tuple comprising a server IP address; SSTP packet information (e.g. Number of SSTP control packets, number of SSTP data packets, Message Type). It will be appreciated that other data may be provided.

In some examples, the tunneling traffic comprises SSH tunneling traffic, and data relating to the tunneling traffic comprises one or more of: for each detected SSH flow: a timestamp for a SSH flow start time and/or stop time; a volume (e.g. in bytes) of the SSH flow; a transport port (e.g. 22); a 5-tuple comprising an SSH server/proxy IP address. It will be appreciated that other data may be provided.

Alternatively, the UPF might report raw data (e.g. raw DNS packets of the tunneling traffic type is DNS)

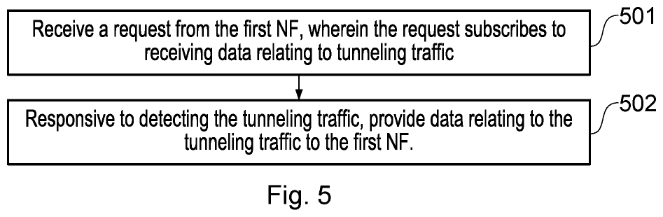

FIG. 5 illustrates a method in a wireless device, for providing data relating to tunneling traffic to a first network function, NF. The first NF may be configured to perform the method as described with reference to FIG. 2.

In step 501 the method comprises receiving a request from the first NF, wherein the request subscribes to receiving data relating to tunneling traffic.

In step 502 the method comprises, responsive to detecting tunneling traffic, providing data relating to the tunneling traffic to the first NF.

In some examples, the request in step 501 comprises an indication of a tunneling traffic type, In these examples, the detected tunneling traffic comprises tunneling traffic of the tunneling traffic type.

In some examples, the tunneling traffic comprises Domain Name System, DNS, tunneling and wherein the data relating to the tunneling traffic comprises one or more of: an indication of whether the tunneling traffic was triggered by a DNS stub resolver at the Operating System, OS, (e.g. Android) of a wireless device or at an application client (e.g. .browsers usually include their own DNS stub resolver); an application identification, ID, indicating which application client triggered the DNS tunneling traffic;

a timestamp for a DNS query and/or a DNS answer; a volume (e.g. in bytes) of a DNS query and/or a DNS answer; a 5-tuple comprising a DNS server IP address; a DNS query type (e.g. A/AAAA); a QNAME in DNS query type A/AAAA; a list of server IP addresses in a DNS answer.

In some examples, the tunneling traffic comprises Internet Protocol Security, IPSec, ICMP, HTTP, QUIC, IPinIP, GRE, IPSec, L2TP, VXLAN, OpenVPN, SSTP or SSH, HTTP, QUIC, IPinIP, GRE, L2TP, VXLAN, OpenVPN, SSTP or SSH tunneling traffic and wherein the data relating to the tunneling traffic comprises one or more of: an application identification, App-ID, indicating which application client triggered the tunneling traffic; a timestamp for a start and/or a stop of the tunneling traffic; a number of packets in the tunneling traffic; a volume of packets in the tunneling traffic; a 5-tuple associated with the tunneling traffic comprising a server IP address.

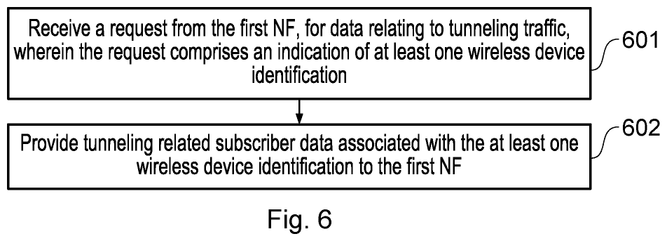

FIG. 6 illustrates a method in a User Data Repository, UDR, for providing data relating to tunneling traffic to a first network function, NF. The first NF may be configured to perform the method as described with reference to FIG. 2.

In step 601, the method comprises receiving a request from the first NF, for data relating to tunneling traffic, wherein the request comprises an indication of at least one wireless device identification. The first NF may be configured to perform the method as described with reference to FIG. 2.

In step 602, the method comprises providing tunneling related subscriber data associated with the at least one wireless device identification to the first NF.

In other words, the UDR may be configured to retrieve subscriber data (specifically historic Tunneling related information for this subscriber).

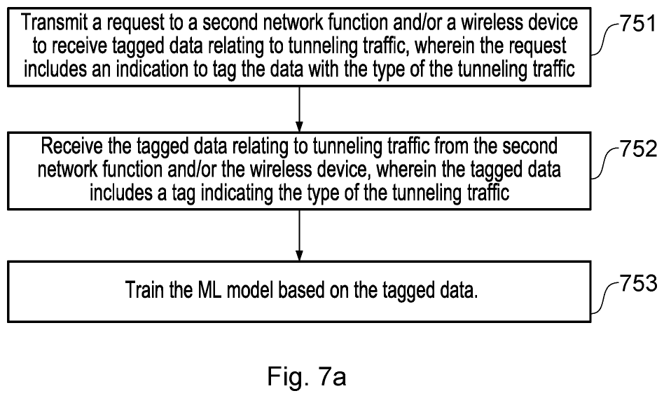

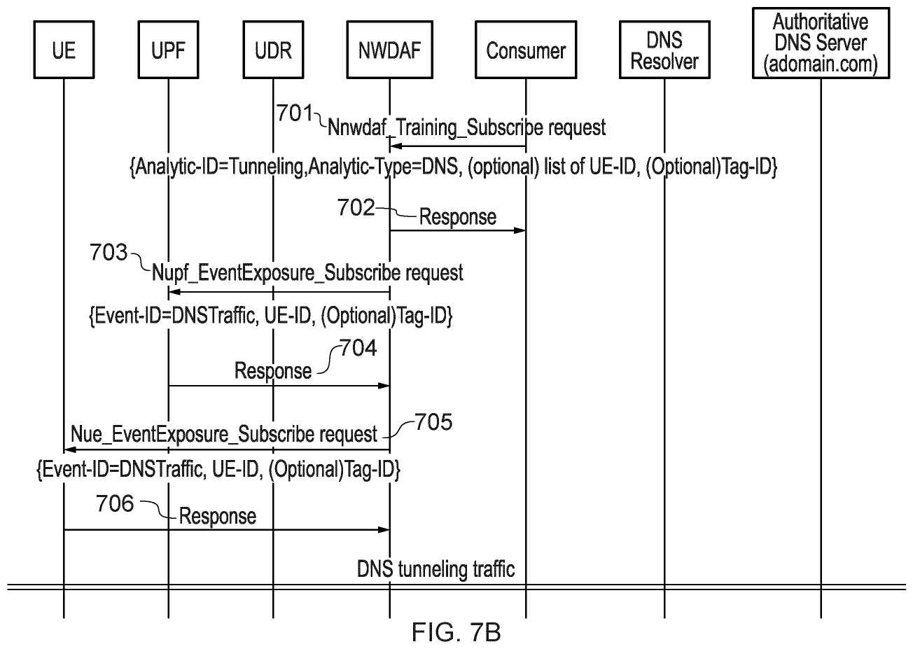

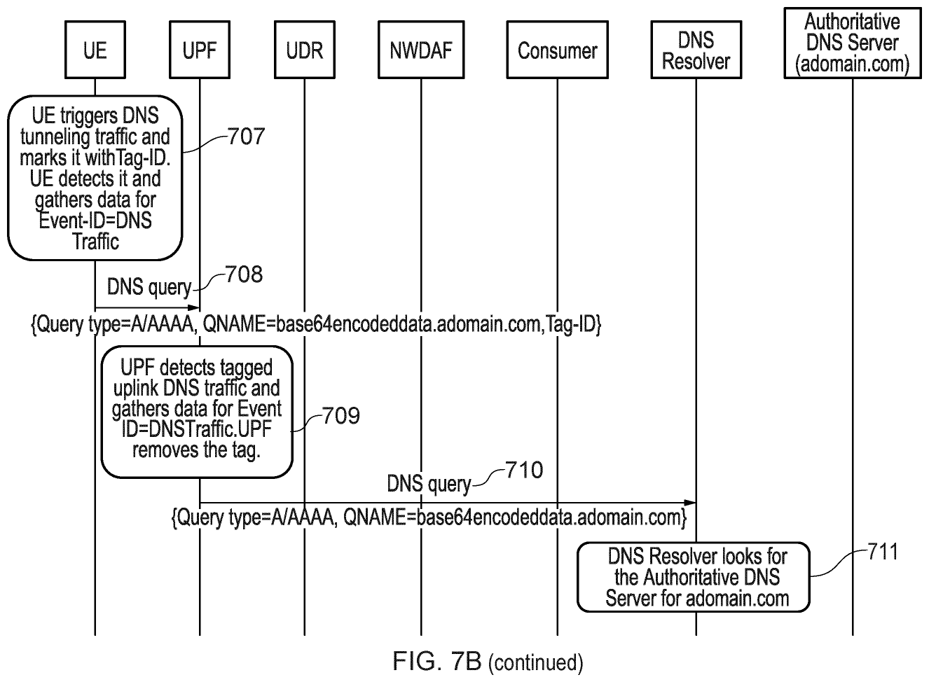

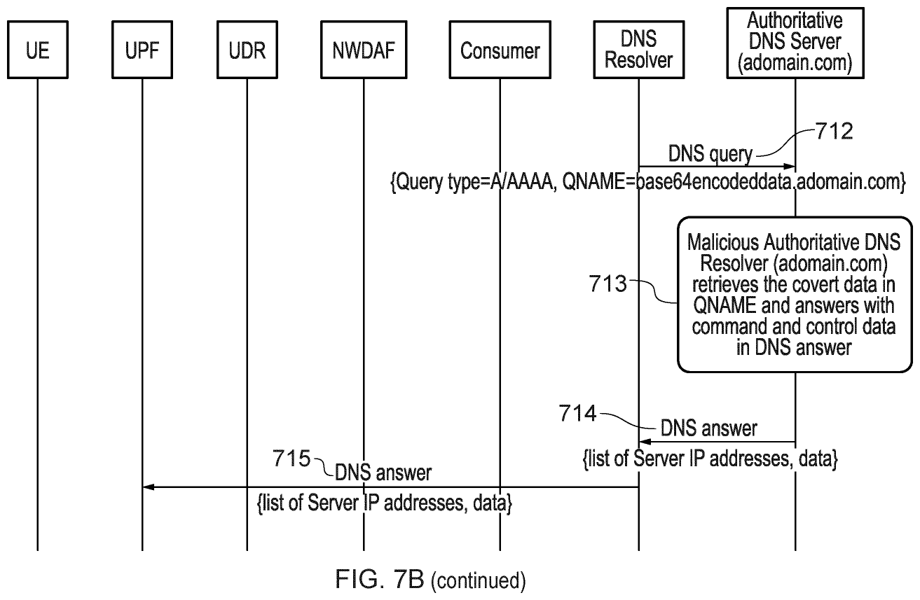

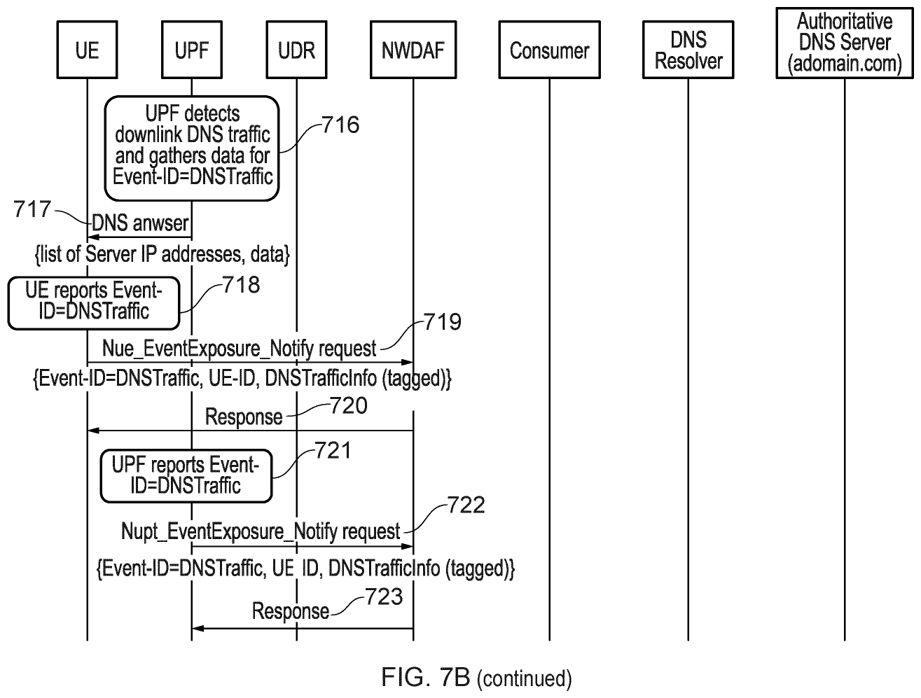

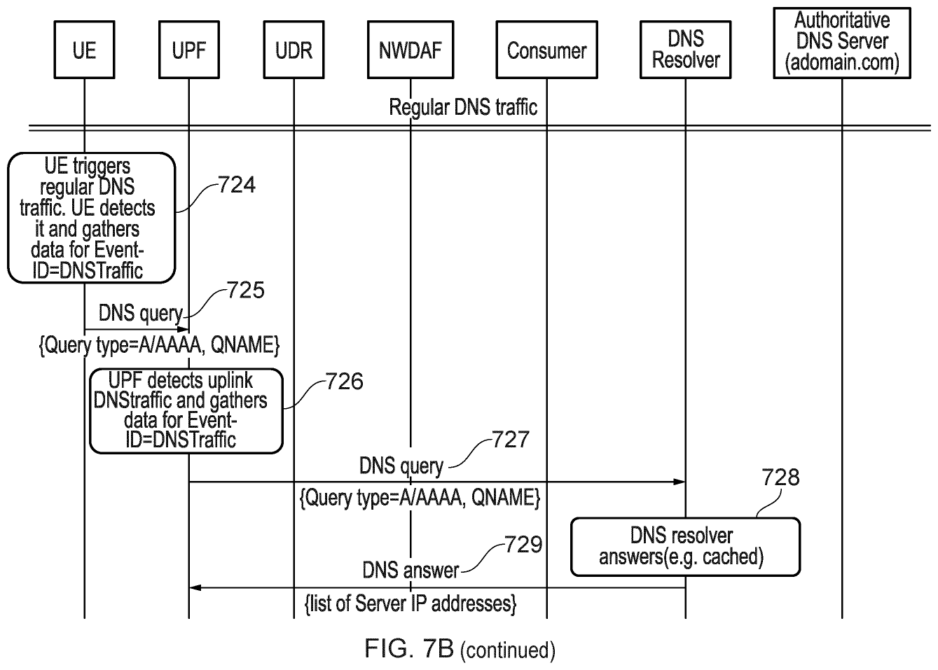

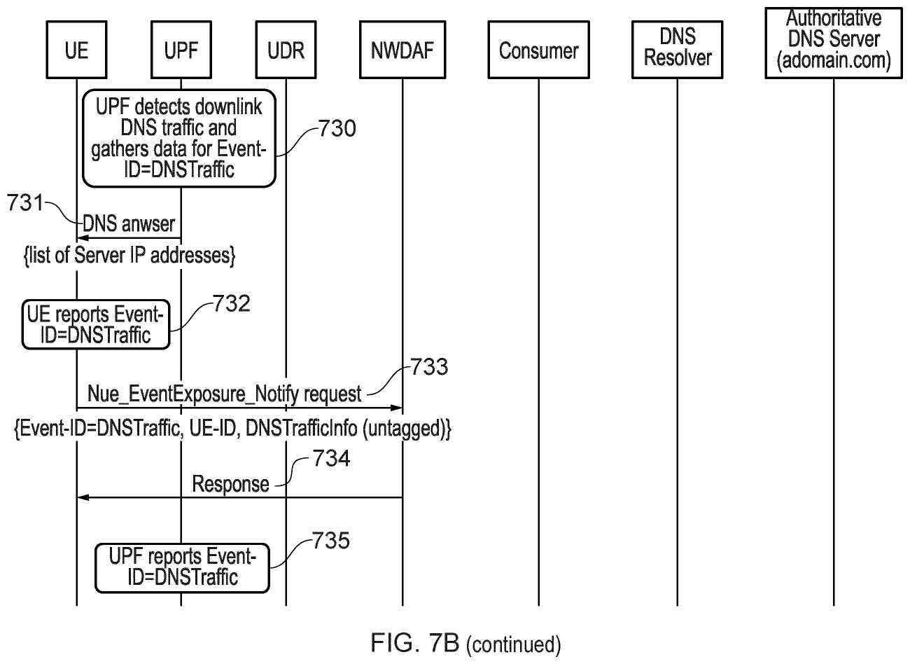

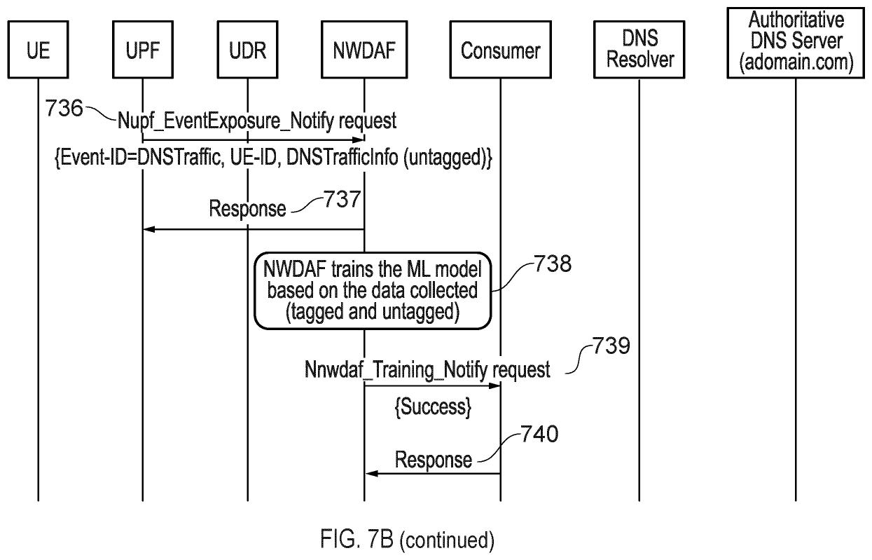

FIG. 7a illustrates a method for training a ML model in a first NF, e.g. a NWDAF. The first network function may also be configured to perform the method as described with reference to FIG. 2.

In step 751 the method comprises transmitting a request to a second network function and/or a wireless device to receive tagged data relating to tunneling traffic, wherein the request includes an indication to tag the data with the type of the tunneling traffic. The second network function may comprise a UPF.

In step 751, the method comprises receiving the tagged data relating to tunneling traffic from the second network function and/or the wireless device, wherein the tagged data includes a tag indicating the type of the tunneling traffic.

In step 753, the method comprises training the ML model based on the tagged data.

FIG. 7b is a sequence diagram illustrating an example implementation of the supervised ML model training process as described with reference to FIG. 7a. In this example, the ML model is being trained to analyse and detect DNS traffic. To train the model, DNS tunneling traffic is marked with Tag-ID (e.g. DSCP marking, IP Options header, etc.).

In step 701, a consumer NF (any NF, e.g. OAM) subscribes to the NWDAF to trigger the training process relative to a new analytic (Analytic-ID=Tunneling), by transmitting a Nnwdaf_Training_Subscribe request message. The Nnwdaf_Training_Subscribe request message may comprise one or more of the following parameters:
Analytic-ID=Tunneling
Tunneling Traffic Type=one or more of: DNS, ICMP, HTTP, QUIC, IPinIP, GRE, IPSec, L2TP, VXLAN, OpenVPN, SSTP, SSH, etc. This parameter indicates the specific tunneling protocol of interest for the consumer NF. When no specific tunneling protocol is included, training is requested irrespective of the tunneling protocol. In the example illustrated in FIG. 7, Tunneling Traffic Type=DNS.
An optional UE-ID or list of UE-IDs, UE-Group-ID or list of UE-Group-IDs, or AnyUE. This parameter indicates the UE(s) which are the target for the tunneling analytics. When not present, AnyUE applies. In the example, illustrated in FIG. 7, this parameter is set to a certain UE (UE-ID).
An optional Tag-ID. This parameter indicates that the traffic is, in this example, DNS tunneling traffic. It will be appreciated that different Tag-IDs may be used for different types of tunneling traffic. It is optional as it is also possible that the Tag-ID value is preconfigured, specifically:
At the UE: to mark the DNS tunneling traffic with Tag-ID
At the UPF: to detect DNS tunneling traffic which is marked with Tag-ID

In step 702, the NWDAF responds to the request of step 701 with a successful response (accepting the request).

In step 703, the NWDAF triggers data collection from UPF, specifically to retrieve information relative to DNS traffic detected by UPF for UE-ID. In order to do this, NWDAF transmits a Nupf_EventExposure_Subscribe request message to the UPF. The Nupf_EventExposure_Subscribe message may comprise one or more of the following parameters:
Event-ID=DNSTraffic
An optional UE-ID or list of UE-IDs, UE-Group-ID or list of UE-Group-IDs, or AnyUE. In this example, this parameter is set to a specific UE-ID.
An optional Tag-ID. This parameter indicates that the traffic is DNS tunneling traffic. It is optional as it is also possible that the Tag-ID value is preconfigured at UPF.

It will be appreciated that, for example, the existing mechanisms proposed in 3GPP TR 23.700-91 (e.g. through SMF or directly, assuming a service based UPF) may be used for the NWDAF triggering data collection from the UPF.

In step 704, the UPF responds to the request message in Step 703 with a successful response (accepting the request).

In step 705, the NWDAF triggers data collection from UE, specifically to retrieve information relative to DNS traffic for UE-ID. In order to do this, NWDAF triggers an Nue_EventExposure_Subscribe request message. The Nue_EventExposure_Subscribe request message may comprise one or more of the following parameters:
Event-ID=DNSTraffic
UE-ID. This indicates the target UE for this event.
(Optional) Tag-ID: this indicates that the traffic is DNS tunneling traffic. It is optional as it is also possible that the Tag-ID value is preconfigured at UE.

It will be appreciated that, for example, the existing mechanisms proposed in 3GPP TR 23.700-91 may be used for the NWDAF to trigger data collection from the UE.

In step 706, UE responds to the request message in 705 with a successful response (accepting the request).

In step 707, the UE triggers DNS tunneling traffic (In this example, a DNS query transmitted to the UPF in step 708) and marks it with Tag-ID. The UE detects the DNS tunneling traffic and gathers data for Event-ID=DNSTraffic. Specifically, the UE may store the following information:
For each detected DNS procedure (DNS query and the corresponding DNS answer):
   Tag-ID: this indicates that the traffic is, in this example, DNS tunneling traffic. Different Tag-IDs may be used for different types of tunneling traffic.
   OS or App triggered: Indicates if the DNS procedure is triggered by the UE DNS stub resolver at the OS (e.g. Android) or at the application client (e.g. browsers usually include their own DNS stub resolver).
   App-ID (example): indicates which application client triggered the DNS procedure.
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA (base64encodeddata.adomain.com)
   List of Server IP addresses in the DNS answer

In step 709 the UPF detects the uplink DNS traffic (the DNS query transmitted to the DNS resolver in step 710), which in this case is marked with Tag-ID and gathers data for Event-ID=DNSTraffic. Specifically, UPF stores the following information:
For each detected DNS procedure (DNS query and the corresponding DNS answer):
   Tag-ID: this indicates that the traffic is, in this example, DNS tunneling traffic. Different Tag-IDs may be used for different types of tunneling traffic.
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA
   List of Server IP addresses in the DNS answer

In step 711, the DNS Resolver looks for the Authoritative DNS Server for adomain.com. In step 712, the DNS Resolver transmits the DNS query to the Authoritative DNS Server.

In this example, the Authoritative DNS Server is Malicious and so in step 713, the (Malicious) Authoritative DNS Server (adomain.com) retrieves the covert data in QNAME (base64encodeddata).

In step 714, the Authoritative DNS Server answers the DNS Query with command and control data in DNS answer.

In step 715 the DNS Answer is forwarded to the UPF by the DNS Resolver.

In step 716, the UPF detects downlink DNS traffic and gathers data for Event-ID=DNSTraffic.

In step 717, the UPF forwards the DNS answer to the UE.

In step 718, the UE continues gathering data for Event-ID=DNSTraffic and at some point (e.g. periodic reporting), UE reports data for Event-ID=DNSTraffic. In order to do that, UE notifies NWDAF in step 719 by triggering a Nue_EventExposure_Notify request message. The Nue_EventExposure_Notify request message may comprise one or more of the following parameters:
Event-ID=DNSTraffic
UE-ID. This indicates the target UE/s for this event.
DNSTrafficInfo. This may comprise the following information (stored in previous steps):
   For each detected DNS procedure (DNS query and the corresponding DNS answer):
      Tag-ID: this indicates that the traffic is, in this example, DNS tunneling traffic. Different Tag-IDs may be used for different types of tunneling traffic.
      OS or App triggered: Indicates if the DNS procedure is triggered by the UE DNS stub resolver at the OS (e.g. Android) or at the application client (e.g. browsers usually include their own DNS stub resolver).
      App-ID (example): indicates which application client triggered the DNS procedure.
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA (base64encodeddata.adomain.com)
      List of Server IP addresses in the DNS answer

In step 720, the NWDAF answers the message in step 719 with a successful response.

In step 721, the UPF continues gathering data for Event-ID=DNSTraffic and at some point (e.g. periodic reporting), UPF reports data for Event-ID=DNSTraffic. In order to do that, UPF notifies NWDAF by transmitting, in step 722, a Nupf_EventExposure_Notify request message. The Nupf_EventExposure_Notify request message may comprise one or more of the following parameters:
Event-ID=DNSTraffic
UE-ID
DNSTrafficInfo. This includes the following information (stored from previous steps):
   For each detected DNS procedure (DNS query and the corresponding DNS answer):
      Tag-ID: this indicates that the traffic is, in this example, DNS tunneling traffic. Different Tag-IDs may be used for different types of tunneling traffic.
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA (base64encodeddata.adomain.com)
      List of Server IP addresses in the DNS answer

In step 723, the NWDAF answers the message in Step 722 with a successful response.

In step 724, the UE triggers regular DNS traffic. UE detects it and gathers data for Event-ID=DNSTraffic. Specifically, the UE may store one or more of the following information:
For each detected DNS procedure (DNS query and the corresponding DNS answer):
   OS or App triggered: Indicates if the DNS procedure is triggered by the UE DNS stub resolver at the OS (e.g. Android) or at the application client (e.g. browsers usually include their own DNS stub resolver).
   App-ID (example): indicates which application client triggered the DNS procedure.
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA
   List of Server IP addresses in the DNS answer.

In step 725, the UE transmits the DNS query to the UPF.

In step 726, the UPF detects uplink DNS traffic, which in this case is not marked with Tag-ID, and gathers data for Event-ID=DNSTraffic. Specifically, UPF may store one or more of the following information:
For each detected DNS procedure (DNS query and the corresponding DNS answer):
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA
   List of Server IP addresses in the DNS answer

In step 727, the UPF forwards the DNS query to the DNS Resolver. In step 728 and 729, the DNS Resolver answers the DNS query (e.g. it has cached the entry).

In step 730, the UPF detects downlink DNS traffic and gathers data for Event-ID=DNSTraffic. In step 731, the UPF forwards the DNS answer to the UE.

In step 732, the UE continues gathering data for Event-ID=DNSTraffic and at some point (e.g. periodic reporting), UE reports data for Event-ID=DNSTraffic. In order to do that, the UE may notify NWDAF by transmitting, in step 733, a Nue_EventExposure_Notify request message. The Nue_EventExposure_Notify request message may comprise one or more of the following parameters:
Event-ID=DNSTraffic
UE-ID. This indicates the target UE/s for this event.
DNSTrafficInfo. This includes the following information (stored in previous steps):
   For each detected DNS procedure (DNS query and the corresponding DNS answer):
      OS or App triggered: Indicates if the DNS procedure is triggered by the UE DNS stub resolver at the OS (e.g. Android) or at the application client (e.g. browsers usually include their own DNS stub resolver).
      App-ID (example): indicates which application client triggered the DNS procedure.
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA
      List of Server IP addresses in the DNS answer

In step 734, the NWDAF answers the message in step 733 with a successful response.

In step 735, the UPF continues gathering data for Event-ID=DNSTraffic and at some point (e.g. periodic reporting), the UPF reports data for Event-ID=DNSTraffic. In order to do that, UPF may notify NWDAF by transmitting in step 736 a Nupf_EventExposure_Notify request message. The Nupf_EventExposure_Notify request message may comprise one or more of the following parameters:
Event-ID=DNSTraffic
UE-ID
DNSTrafficInfo. This includes the following information (stored from previous steps):
   For each detected DNS procedure (DNS query and the corresponding DNS answer):
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA
      List of Server IP addresses in the DNS answer

In step 737, the NWDAF answers the message in step 736 with a successful response.

In step 738, the NWDAF trains the ML model based on the data collected (tagged and untagged). The resulting ML model can be obtained through supervised ML algorithms such as decision tree, random forest, regression, etc. In step 739, the NWDAF may notify the consumer NF that the training process has finished by triggering a Nnwdaf_Training_Notify request message indicating successful operation.

In step 740, the Consumer NF answers the message in step 739 with a successful response.

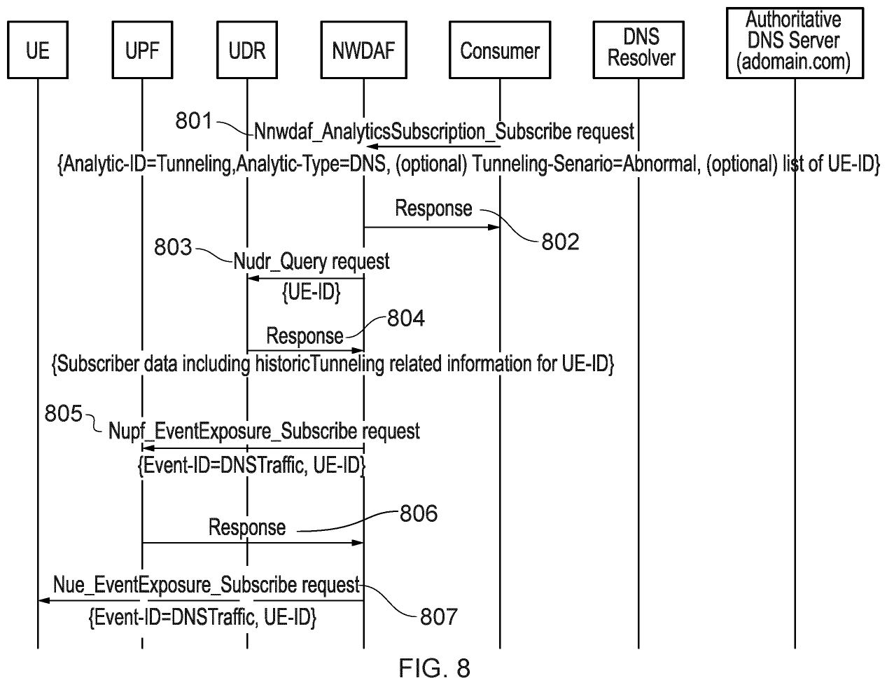

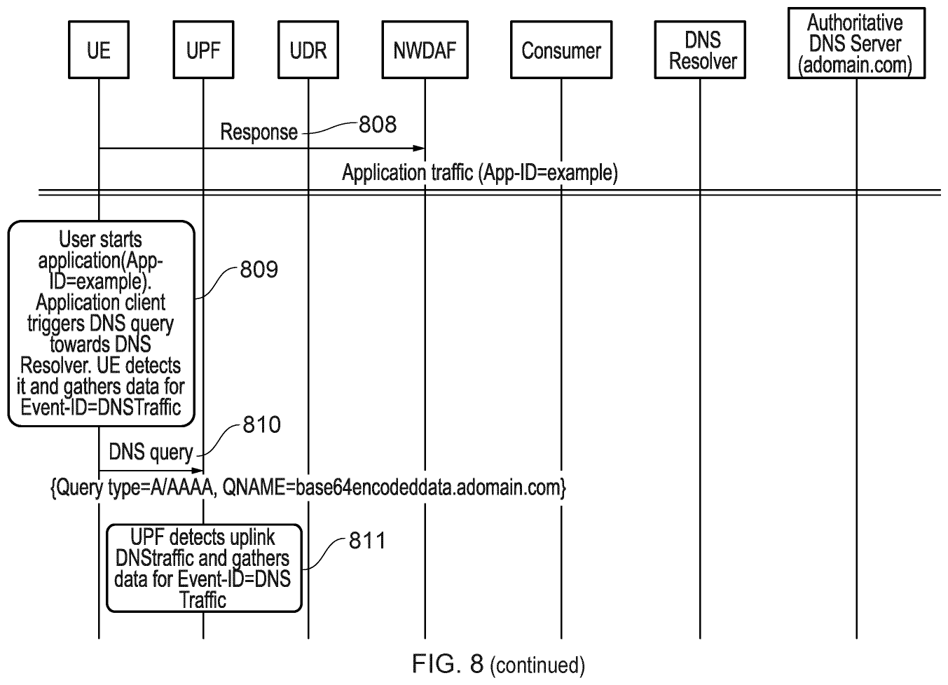

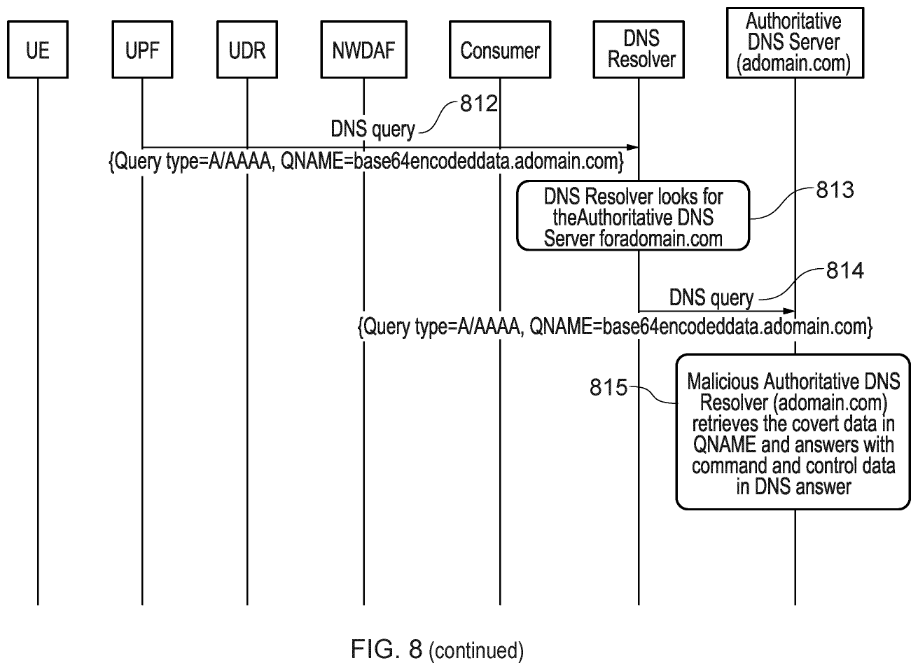

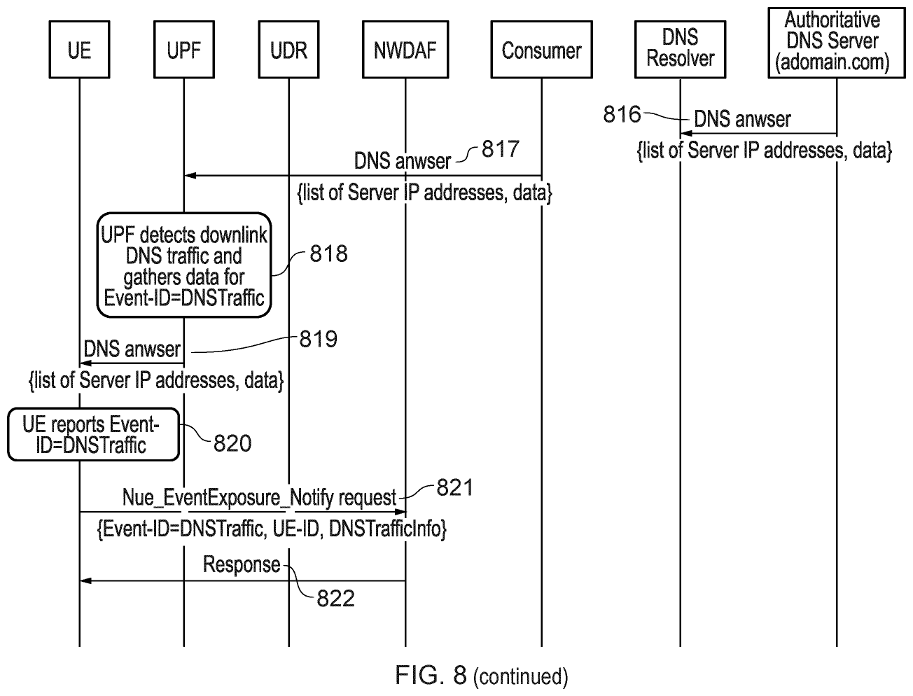

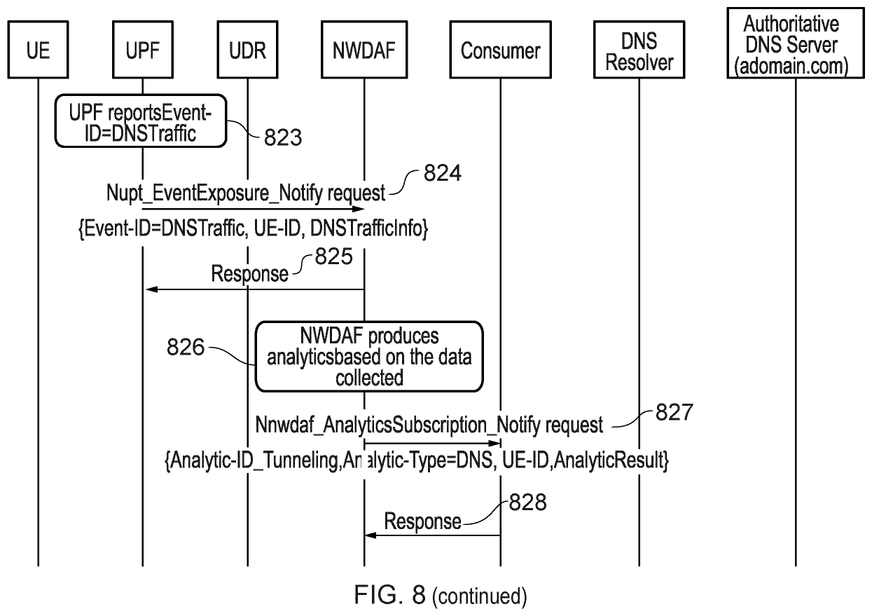

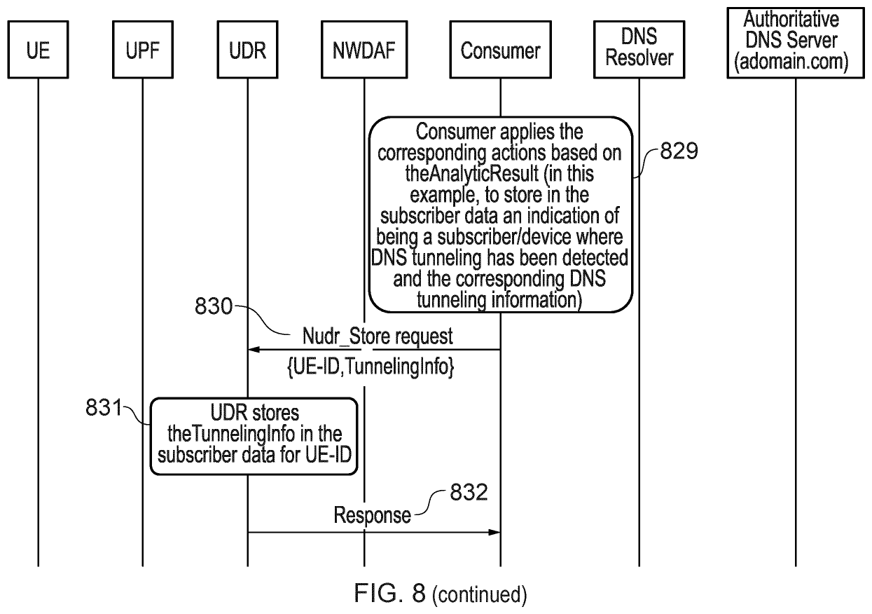

To exemplify the embodiments described above in FIGS. 2 to 6, use cases are described in the following FIGS. 8 to 10.

FIG. 8 illustrates an example implementation of the methods of FIGS. 2 to 6. This example illustrates a use case to prevent security attacks through DNS tunneling.

In step 801, a consumer NF (e.g. any suitable NF, e.g. PCF or OAM) subscribes to the NWDAF to receive an analytic result relating to tunneling traffic (Analytic-ID=Tunneling). This may be done by transmitting a Nnwdaf_AnalyticsSubscription_Subscribe request message to the NWDAF. The Nnwdaf_AnalyticsSubscription_Subscribe request message may comprise one or more of the following parameters:
Analytic-ID=Tunneling Tunneling Traffic Type=DNS, ICMP, HTTP, QUIC, IPinIP,
GRE, IPSec, L2TP, VXLAN, OpenVPN, SSTP, SSH, etc. Indicates the specific tunneling protocol of interest for the consumer. When no specific tunneling protocol is included, it requests tunneling analytics irrespective of the tunneling protocol. In the example Use Case shown in the sequence diagram of FIG. 8, Analytic-Type=DNS.
Tunneling-Scenario=Normal (e.g. VPN), Abnormal (e.g. Fraud, Security). Indicates the specific tunneling scenario of interest for the consumer. When not present, it requests tunneling analytics irrespective of the tunneling scenario. In the example illustrated in FIG. 8, this field is set to Abnormal. Optionally, a more specific scenario can be indicated (e.g. Security within the Abnormal category).
(Optional) UE-ID or list of UE-ID, UE-Group-ID or list of UE-Group-ID, AnyUE. This indicates the UE/s which are the target for tunneling analytics. When not present, AnyUE applies. In the example of FIG. 8, this field is set to a certain UE (UE-ID).

In step 802, the NWDAF answers the request message in step 801 with a successful response (accepting the request).

In step 803, the NWDAF triggers data collection from UDR. In order to do this, NWDAF may request the UDR for the subscriber data relative to the UE-ID received in step 801. In order to do this, the NWDAF may transmit an Nudr_Query request message to the UDR indicating UE-ID as parameter.

In step 804, the UDR returns the subscriber data for UE-ID, for example, comprising historic DNS tunneling related information for UE-ID.

In step 805, the NWDAF triggers data collection from UPF, specifically to retrieve information relative to DNS traffic detected by UPF for UE-ID. In order to do this, the NWDAF may transmit a Nupf_EventExposure_Subscribe request message to the UPF. The Nupf_EventExposure_Subscribe request message may comprise one or more of the following parameters:
Event-ID=DNSTraffic
UE-ID. This indicates the target UE/s for this event.

It will be appreciated that, for example, the existing mechanisms proposed in 3GPP TR 23.700-91 may be used (e.g. through SMF or directly, assuming a service based UPF) for the NWDAF to trigger data collection from the UPF.

In step 806, the UPF answers the request message in step 805 with a successful response (accepting the request). appropriate

In step 807, the NWDAF triggers data collection from the UE, specifically to retrieve information relative to DNS traffic for UE-ID. In order to do this, NWDAF may transmit a Nue_EventExposure_Subscribe request message to the UE. The Nue_EventExposure_Subscribe request message may comprise one or more of the following parameters:
Event-ID=DNSTraffic
UE-ID. This indicates the target UE/s for this event.

It will be appreciated that, for example, the existing mechanisms proposed in 3GPP TR 23.700-91 may be used for the NWDAF to trigger data collection from the UE.

In step 808, the UE answers the request message in step 807 with a successful response (accepting the request).

In step 809, a User of the UE starts an application (App-ID=example). The UE detects the starting of the application and gathers data for Event-ID=DNSTraffic. Specifically, UE may store one or more of the following information:
For each detected DNS procedure (DNS query and the corresponding DNS answer):
   OS or App triggered: Indicates if the DNS procedure is triggered by the UE DNS stub resolver at the OS (e.g. Android) or at the application client (e.g. browsers usually include their own DNS stub resolver).
   App-ID (example): indicates which application client triggered the DNS procedure.
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA (base64encodeddata.adomain.com)
   List of Server IP addresses in the DNS answer

In step 810, the UE transmits a DNS query to the UPF.

In step 811, the UPF detects the uplink DNS traffic and gathers data for Event-ID=DNSTraffic. Specifically, the UPF may store one or more of the following information:
For each detected DNS procedure (In this example, the DNS query and the corresponding DNS answer):
   Timestamp (DNS query and DNS answer)
   Volume (e.g. in bytes) of the DNS query and the DNS answer
   5-tuple (including DNS server IP address)
   DNS query type (e.g. A/AAAA)
   QNAME in DNS query type A/AAAA
   List of Server IP addresses in the DNS answer

In step 812, the UPF forwards the DNS query to a DNS Resolver.

In step 813, the DNS Resolver looks for the Authoritative DNS Server for adomain.com.

In step 814, the DNS Resolver forwards the DNS query to the Authoritative DNS Server.

In step 815, the (Malicious) Authoritative DNS Resolver (adomain.com) retrieves the covert data in QNAME (base64encodeddata) and in step 816 answers with command and control data in a DNS answer to the DNS Resolver.

In step 817, the DNS Resolver forwards the DNS answer to the UPF.

In step 818, the UPF detects downlink DNS traffic and gathers data for Event-ID=DNSTraffic.

In step 819, the UPF forwards the DNS answer to the UE.

In step 820, the UE continues gathering data for Event-ID=DNSTraffic and at some point (e.g. periodic reporting), UE reports data for Event-ID=DNSTraffic. In order to do that, UE may notify NWDAF by transmitting in step 821 a Nue_EventExposure_Notify request message. The Nue_EventExposure_Notify request message may comprise one or more of the following parameters:
Event-ID=DNSTraffic
UE-ID. This indicates the target UE/s for this event.
DNSTrafficInfo. This includes the following information (stored in previous steps):
   For each detected DNS procedure (In this example, the DNS query and the corresponding DNS answer):
      OS or App triggered: Indicates if the DNS procedure is triggered by the UE DNS stub resolver at the OS (e.g. Android) or at the application client (e.g. browsers usually include their own DNS stub resolver).
      App-ID (example): indicates which application client triggered the DNS procedure.
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA (base64encodeddata.adomain.corn)
      List of Server IP addresses in the DNS answer

In step 822, the NWDAF answers the message in step 821 with a successful response.

In step 823, the UPF continues gathering data for Event-ID=DNSTraffic and at some point (e.g. periodic reporting), the UPF reports data for Event-ID=DNSTraffic. In order to do that, the UPF may notify the NWDAF by transmitting in step 824 a Nupf_EventExposure_Notify request message. The Nupf_EventExposure_Notify request message may comprise one or more of the following parameters:
Event-ID=DNSTraffic
UE-ID
DNSTrafficInfo. This includes the following information (stored from previous steps):
   For each detected DNS procedure (In this example, the DNS query and the corresponding DNS answer):
      Timestamp (DNS query and DNS answer)
      Volume (e.g. in bytes) of the DNS query and the DNS answer
      5-tuple (including DNS server IP address)
      DNS query type (e.g. A/AAAA)
      QNAME in DNS query type A/AAAA (base64encodeddata.adomain.corn)
      List of Server IP addresses in the DNS answer

In step 825, the NWDAF answers the message in step 824 with a successful response.

In step 826, the NWDAF determines an analytic result based on the data collected from one or more of the UDR, UE and UPF. To detect DNS tunneling, in this example, the NWDAF uses a Machine Learning model (which may, for example, be obtained through the training process described in FIG. 7).

Additionally (or alternatively), the NWDAF may search for unexpected or uncorrelated DNS data that is indicative of DNS tunneling. As an example, the NWDAF might analyze both timestamps and volume, in case there is an unusually large number of DNS queries for a single domain (adomain.com) and each query includes e.g. a unique subdomain of arbitrary data (base64encodeddata). If the NWDAF does determine that there is an unusually large number of DNS queries for a single domain (adomain.com) and each query includes e.g. a unique subdomain of arbitrary data (base64encodeddata) the NWDAF may determine that DNS tunneling is happening and may store one or more of the following information:
Tunneling Traffic Type=DNS
List of UE-IDs. This list may identify which UE-IDs have been found to use tunneling (on a per tunneling protocol basis). Each UE-ID might include the subscriber identifier (SUPI/IMSI), the subscriber public identifier (PUI/MSISDN) and/or device identifier (PEI/IMEI), In the example illustrates in FIG. 8 the list of UE-IDs comprises a single UE-ID.
An indication of normal or abnormal scenario. In this example, the NWDAF determines that the tunneled traffic (for the requested tunneling protocol) corresponds to an abnormal scenario (e.g. security related attack). Optionally a confidence level associated with the indication of a normal or abnormal scenario may be included (e.g. a percentage from 0% to 100%).
A list of (suspect) Domains. The list of domains may identify the target domain/s for the tunneling traffic. In this example, for the DNS query with QNAME including the subdomain that represents an encoded communication (base64encodeddata.adomain.com), the domain will be adomain.com
A List of (suspect) App-IDs. This list may identify the App-IDs generating the tunneling traffic. In this example, App-ID=example.
A List of (suspect) Server IPs. This list may identifies the Server IP addresses (as tunnel endpoints). In this example, this may comprise a DNS tunnel endpoint.
Tunneled volume. This may comprise the percentage of tunneled traffic with respect to the total traffic volume. In this example, the tunneled volume may be the tunneled DNS volume and a percentage with respect to the total UE-ID session volume (or to the total DNS volume).
At least one recommended traffic management action. The recommended traffic management action might be determined by the NWDAF based both on the detected type of tunneling and on the confidence level. In this example, the NWDAF determines that tunneled traffic corresponds to a fraud or security scenario. If the confidence level is high: the recommended traffic management action may comprise blocking tunneled traffic to the suspect domains and/or Server IPs. Additionally, or Alternatively, the recommended traffic management action may comprise blocking tunneled traffic for the suspect App-ID/s. If confidence level is medium, the recommended traffic management action may comprise traffic steering, for example, to steer a copy of the tunneled traffic towards an offline analytics engine.
The at least one recommended traffic management action may also comprise storing information relating to the tunneling as part of subscriber data, for example, at the UPF.

In step 827, the NWDAF may transmit an analytic result to the Consumer NF. For example, the NWDAF may transmit a Nnwdaf_AnalyticsSubscription_Notify request message. The Nnwdaf_AnalyticsSubscription_Notify request message may comprise one or more of the following parameters:
Analytic-ID=Tunneling
Tunneling Traffic Type=DNS
List of UE-IDs. This identifies which UE-IDs have been found to use tunneling (on a per tunneling protocol basis). Each UE-ID might include the subscriber identifier (SUPI/IMSI), the subscriber public identifier (PUI/MSISDN) and/or device identifier (PEI/IMEI). In this example (FIG. 3), a single UE-ID.
AnalyticResult. This may comprise some or all of the information determined in step 827 above.

In step 828, the consumer NF answers the message in step 827 with a successful response.

In step 829, in this example, the consumer NF applies the corresponding recommended traffic management action(s) based on the AnalyticResult. In this example, the consumer NF to store in the subscriber data an indication of being a subscriber/device where DNS tunneling has been detected and the corresponding DNS tunneling information) In order to do this, the consumer NF transmits, in step 830 towards the UDR a

Nudr_Store request message. The Nudr_Store request message may comprise one or more of the following parameters:
UE-ID.
TunnelingInfo, including:
   Tunneling Traffic Type=DNS
   Indication of abnormal scenario (e.g. security related attack), and optionally including a confidence level (e.g. a percentage from 0% to 100%).
   (Optional) List of (suspect) Domains (in this example, adomain.corn).
   (Optional) List of (suspect) App-IDs (in this example, App-ID=example).
   (Optional) List of (suspect) Server IPs.

In step 831, the UDR stores the TunnelingInfo in the subscriber data for UE-ID.

In step 832, the UDR answers the message in step 830 with a successful response.

Whilst it is not illustrated in FIG. 8, it will be appreciated that many different recommended traffic management actions may be triggered by the consumer NF based on the AnalyticResult, for example as described above with reference to FIG. 2.

The TunnelingInfo stored in the UDR may be used in subsequent sessions for UE-ID, e.g. to continue monitoring Tunneling for UE-ID and, if the same behavior is found and/or if the accumulated suspect Tunneled volume exceeds a configured threshold, the user may be notified accordingly.

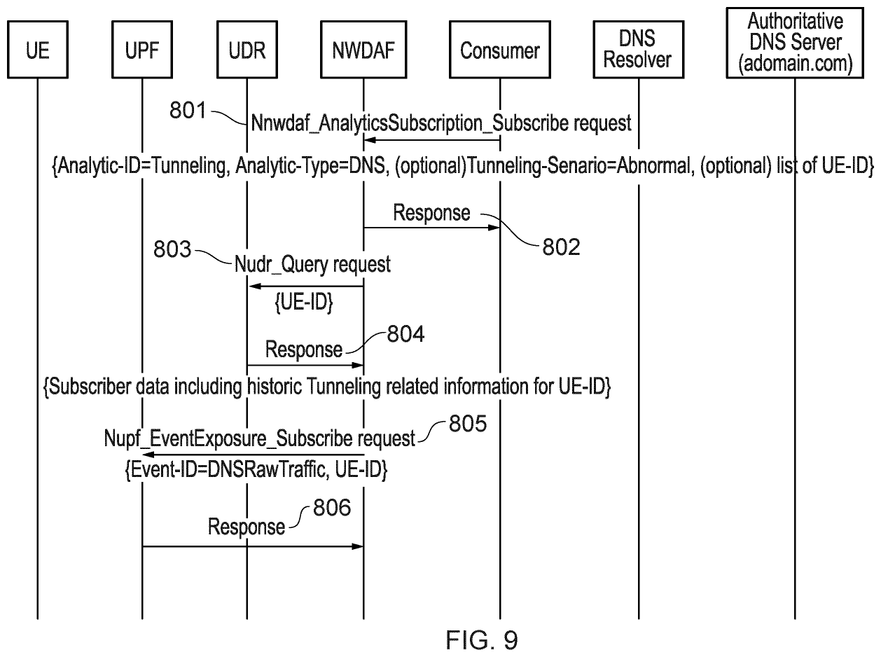

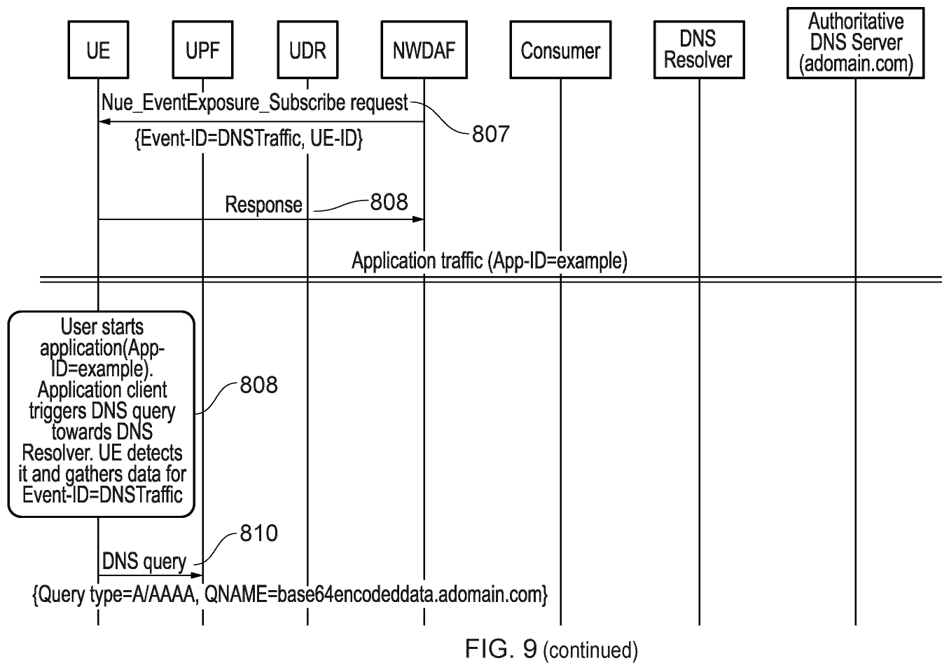

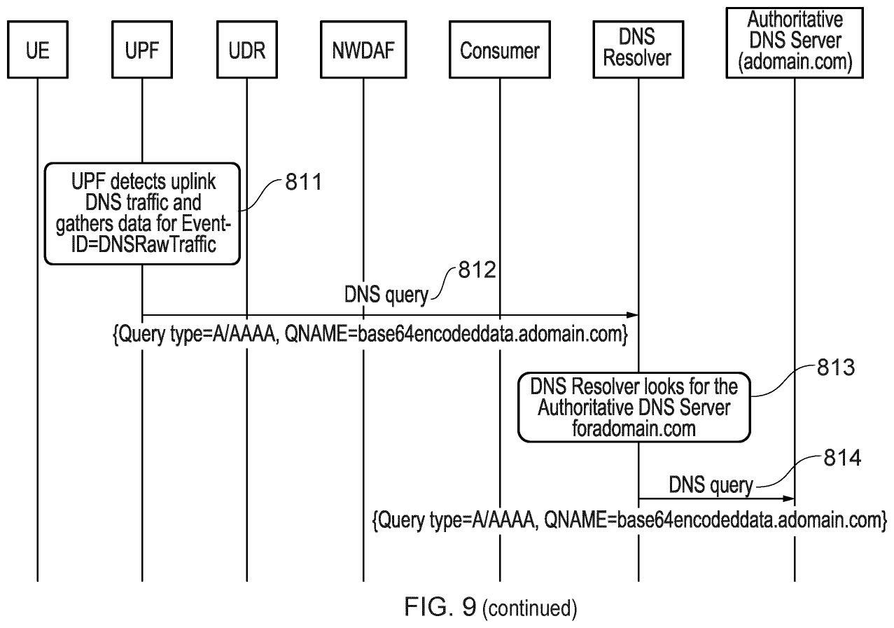

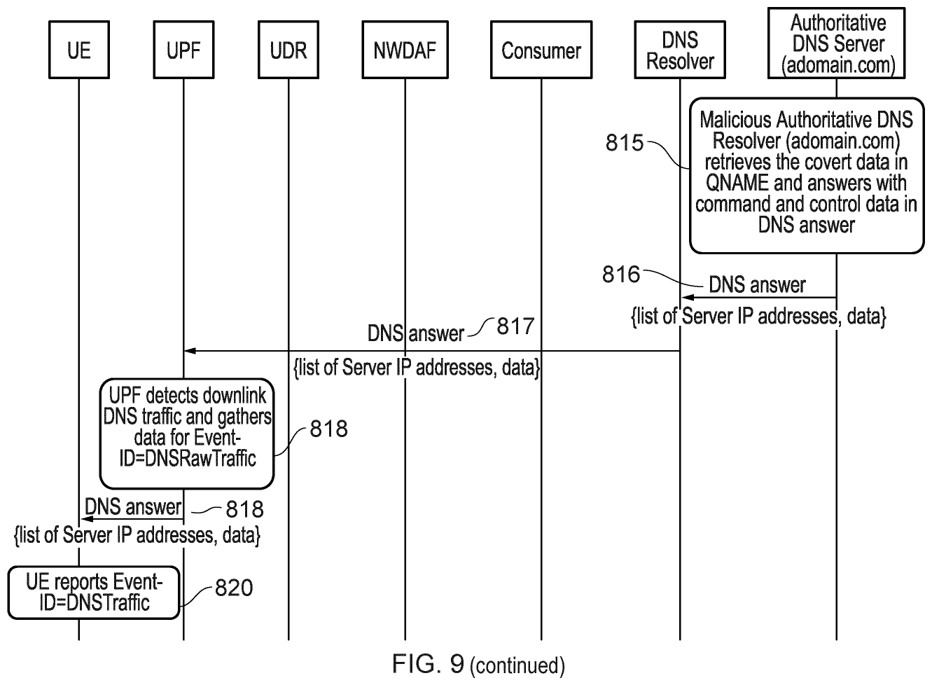

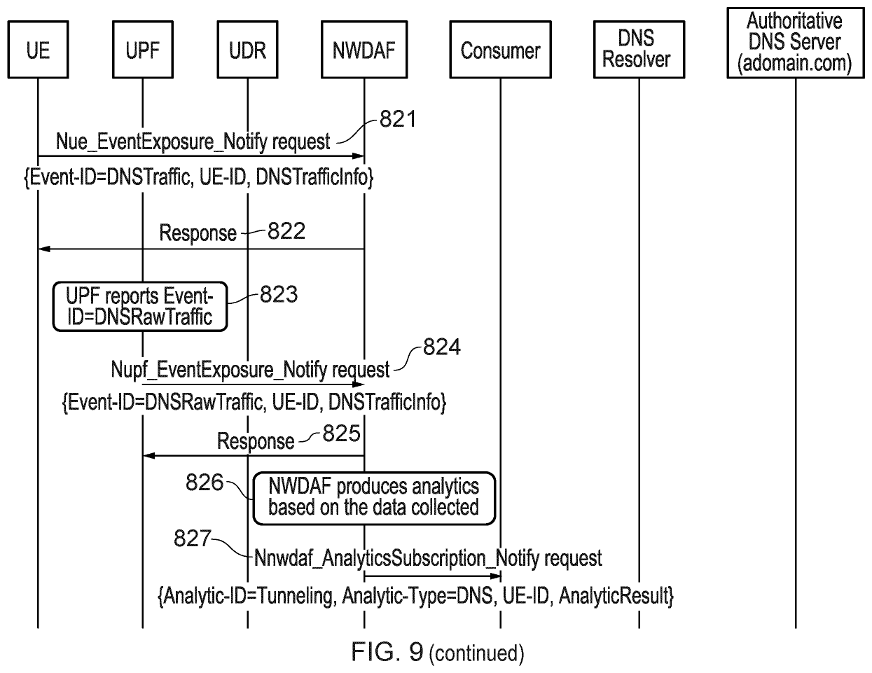

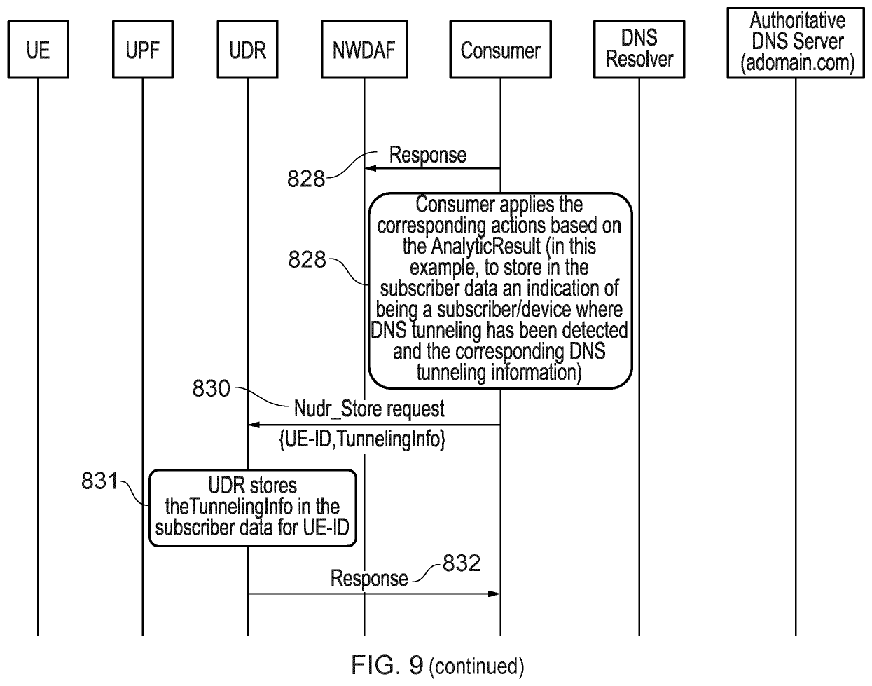

FIG. 9 is a sequence diagram illustrating an example implementation of the methods of FIGS. 2 to 6. In this example data collection from UPF is relative to DNS raw data. Most of the steps are the same as described with reference to FIG. 9. The steps 805, 811, 818 and 823 are different, and the changes are described below.

In step 805, the NWDAF triggers data collection from UPF, specifically to retrieve information relative to DNS traffic detected by UPF for UE-ID. In order to do this, NWDAF triggers a Nupf_EventExposure_Subscribe request message including the following parameters:
Event-ID=DNSRawTraffic
UE-ID. This indicates the target UE/s for this event.

In step 811, the UPF detects uplink DNS traffic and gathers data for Event-ID=DNSRawTraffic. Specifically, UPF stores the following information:
For each detected DNS flow:
   A Timestamp for a start time and/or stop time for the flow
   Raw IP packets for the whole DNS flow

In step 818, the UPF detects downlink DNS traffic and gathers data for Event-ID=DNSRawTraffic.

In step 823, the UPF continues gathering data for Event-ID=DNSRawTraffic and at some point (e.g. periodic reporting), UPF reports data for Event-ID=DNSRawTraffic. In order to do that, the UPF may notify the NWDAF by transmitting in step 824 Nupf_EventExposure_Notify request message. The Nupf_EventExposure_Notify request message may comprise the following parameters:
Event-ID=DNSRawTraffic
UE-ID
DNSRawTrafficlnfo. This includes the following information (stored from previous steps):
   For each detected DNS flow:
      A timestamp for a start time and/or stop time for the flow
      Raw IP packets for the whole DNS flow

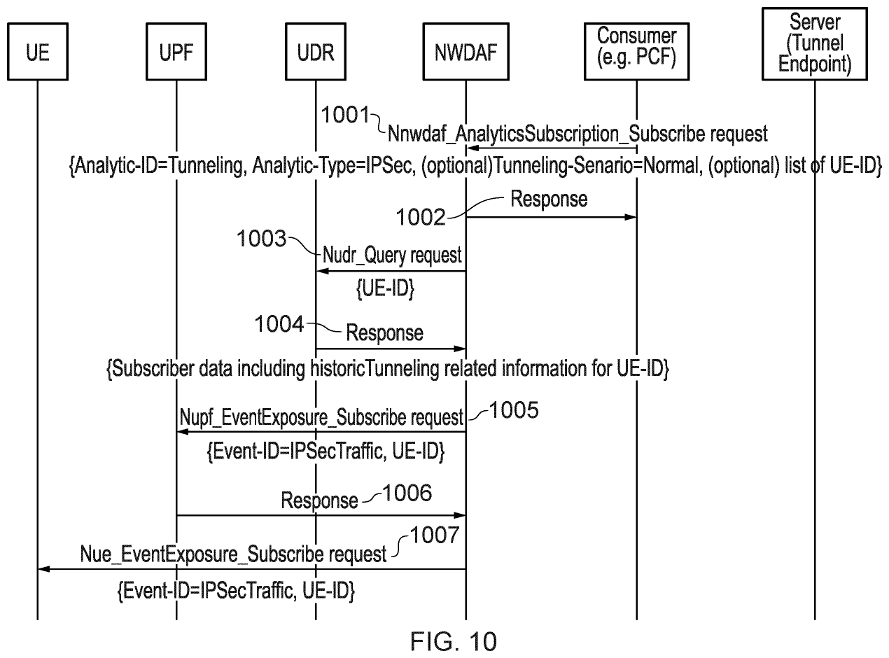

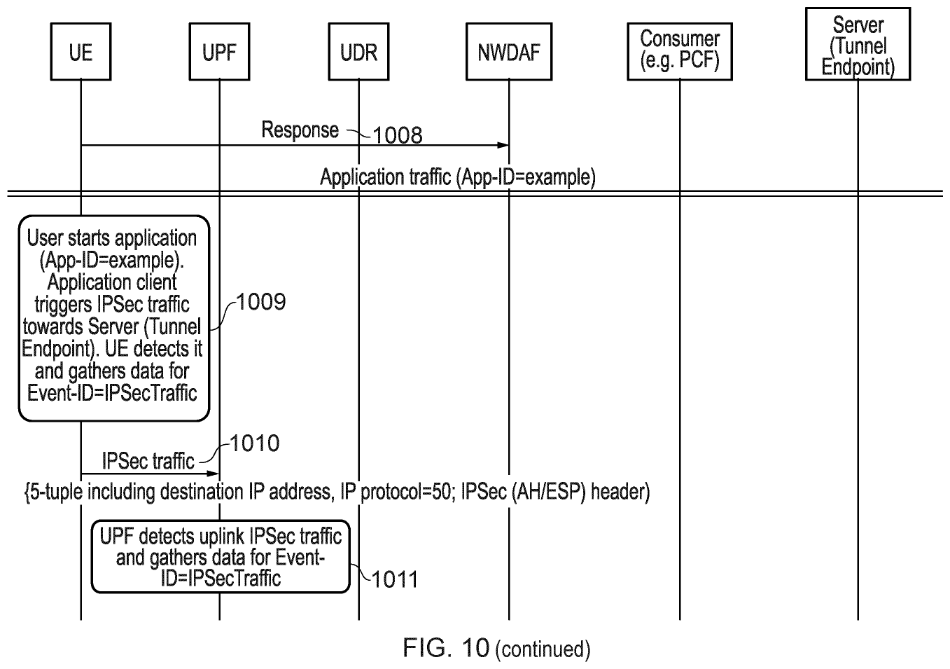

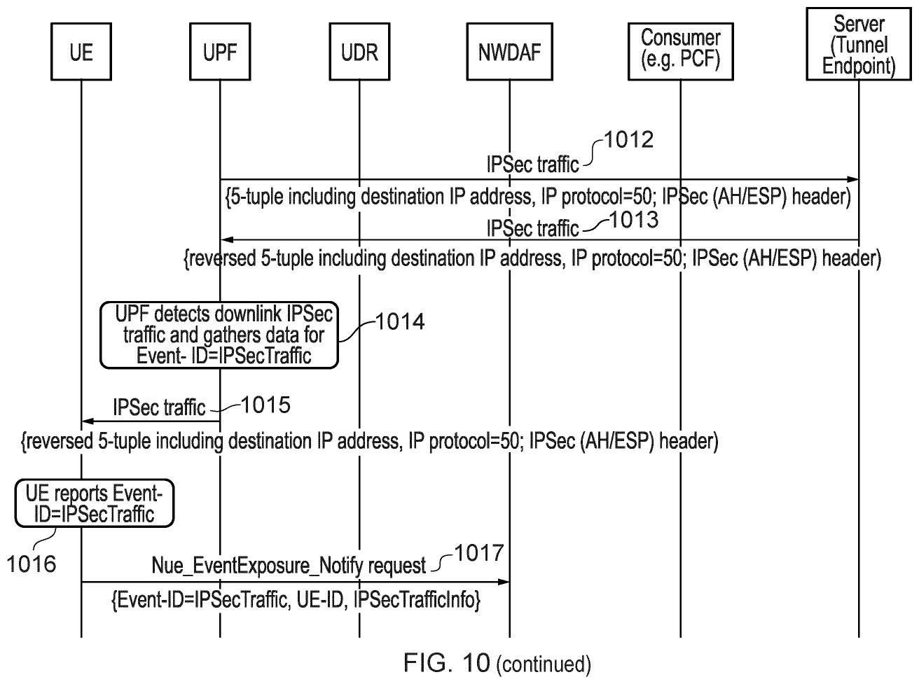

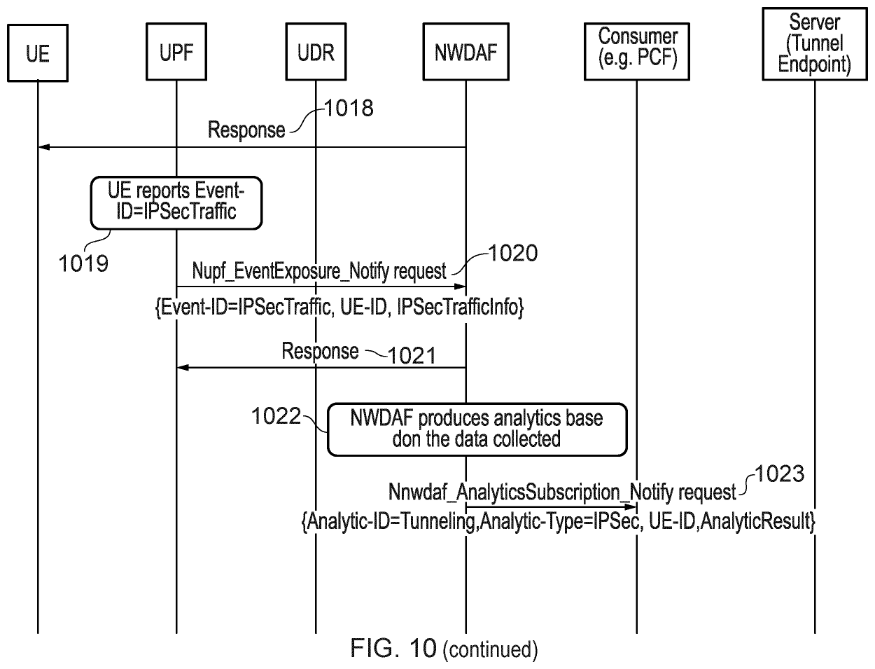

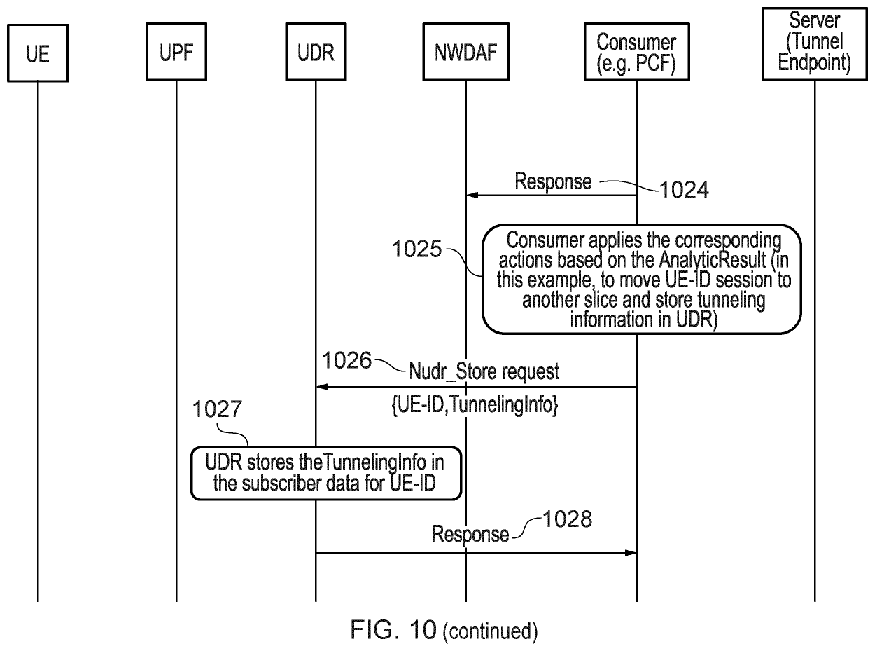

FIG. 10 is a sequence diagram illustrating an example implementation of the method of FIGS. 2 to 6. In this example, the method is used to detect and control VPN tunneled traffic through IPSec. In this example, a trained ML model is available at NWDAF. This ML model may be trained in a similar manner to as described with reference to FIG. 7.

In step 1001, a consumer NF (any suitable NF, e.g. PCF or OAM) subscribes to the NWDAF to receive an analytic result relating to tunneling traffic (Analytic-ID=Tunneling). For example, the consumer NF may transmit a Nnwdaf_AnalyticsSubscription_Subscribe request message to the NSDAF. The Nnwdaf_AnalyticsSubscription_Subscribe request message may comprise one or more of the following parameters:
Analytic-ID=Tunneling
Tunneling Traffic Type=IPSec,
Tunneling-Scenario=Normal Optionally, a more specific scenario can be indicated (e.g. VPN within the Normal category).
UE-ID

In step 1002, the NWDAF answers the request message in step 1001 with a successful response (accepting the request).

In step 1003, the NWDAF triggers data collection from UDR. For example, the NWDAF requests UDR for the subscriber data relative to UE-ID. In order to do this, the NWDAF may transmit a Nudr_Query request message indicating UE-ID as parameter.

In step 1004, the UDR returns the subscriber data for UE-ID, for example, comprising historic IPSec tunneling related information for UE-ID.

In step 1005, the NWDAF triggers data collection from the UPF, specifically to retrieve information relative to IPSec traffic detected by UPF for UE-ID. In order to do this, the NWDAF may transmit a Nupf_EventExposure_Subscribe request message. The Nupf_EventExposure_Subscribe request message may comprise one or more of the following parameters:
Event-ID=IPSecTraffic
UE-ID. This indicates the target UE/s for this event.

It will be appreciated that the existing mechanisms proposed in 3GPP TR 23.700-91 may be used (e.g. through SMF or directly, assuming a service based UPF) for the NWDAF to trigger data collection from the UPF.

In step 1006, the UPF answers the request message in step 1005 with a successful response (accepting the request).

In step 1007, the NWDAF triggers data collection from the UE, specifically to retrieve information relative to IPSec traffic for UE-ID. In order to do this, the NWDAF may transmit a Nue_EventExposure_Subscribe request message. The Nue_EventExposure_Subscribe request message may comprise one or more of the following parameters:
Event-ID=IPSecTraffic
UE-ID. This indicates the target UE/s for this event.

It will be appreciated that the existing mechanisms proposed in 3GPP TR 23.700-91 may be used for the NWDAF to trigger data collection from the UE.

In step 1008, the UE answers the request message in step 1007 with a successful response (accepting the request).

In step 1009, the User of the UE starts application (App-ID=example). The application client triggers IPSec traffic towards the Server (Tunnel endpoint). The UE detects the IPSec traffic and gathers data for Event-ID=IPSecTraffic. Specifically, the UE may store one or more of the following information:
For each detected IPSec flow (not an exhaustive list):
   App-ID: indicates which application client triggered the IPSec flow.
   Timestamp (IPSec flow start and stop)
   Number of packets in the flow
   Volume of packets in the flow (e.g. in bytes)
   5-tuple (including server IP address)

In step 1010, the UE transmits the IPSec traffic to the UPF.

In step 1011, the UPF detects the uplink IPSec traffic and gathers data for Event-ID=IPSecTraffic. Specifically, the UPF may store one of more of the following information:
For each detected IPSec flow (not an exhaustive list):
   Timestamp (IPSec flow start and stop)
   Volume (e.g. in bytes) of the IPSec flow
   IP Protocol Number (e.g. 50 or 51)
   Outer IP header source/destination IP address
   If AH header present:
      AH header information (e.g. SPI)
   If ESP header present:
      ESP header information (e.g. SPI)

In step 1012, the UPF forwards the IPSec traffic to the IPSec tunnel endpoint.

In step 1013, IPSec tunnel endpoint transmits IPSec traffic to the UPF.

In step 1014, the UPF detects downlink IPSec traffic and gathers data for Event-ID=IPSecTraffic.

In step 1015, the UPF forwards the IPSec traffic to the UE.

In step 1016, the UE continues gathering data for Event-ID=IPSecTraffic and at some point (e.g. periodic reporting), UE reports data for Event-ID=IPSecTraffic. In order to do that, the UE may notify the NWDAF by transmitting, in step 1017, a Nue_EventExposure_Notify request message. The Nue_EventExposure_Notify request message may comprise one or more of the following parameters:
Event-ID=IPSecTraffic
UE-ID
IPSecTrafficInfo. This includes the following information (stored in previous steps):
   For each detected IPSec flow (not an exhaustive list):
      App-ID: indicates which application client triggered the IPSec flow.
      Timestamp (IPSec flow start and stop)
      Number of packets in the flow
      Volume of packets in the flow (e.g. in bytes)
      5-tuple (including server IP address)

In step 1018, the NWDAF answers the message in step 1017 with a successful response.

In step 1019, the UPF continues gathering data for Event-ID=IPSecTraffic and at some point (e.g. periodic reporting), UPF reports data for Event-ID=IPSecTraffic. In order to do that, the UPF may notify the NWDAF by transmitting in step 1020 a Nupf_EventExposure_Notify request message. The Nupf_EventExposure_Notify request message may comprise one or more of the following parameters:
Event-ID=IPSecTraffic
UE-ID
IPSecTrafficInfo. This includes the following information (stored from previous steps):
   For each detected IPSec flow (not an exhaustive list):
      Timestamp (IPSec flow start and stop)
      Volume (e.g. in bytes) of the IPSec flow
      IP Protocol Number (e.g. 50 or 51)
      Outer IP header source/destination IP address
      If AH header present:
         AH header information (e.g. SPI)
      If ESP header present:
         ESP header information (e.g. SPI)

In step 1021, the NWDAF answers the message in step 1020 with a successful response.

In step 1022, the NWDAF determines an analytic result based on the data collected from UDR, UE and UPF. To detect VPN traffic, the NWDAF, in this example, uses a Machine Learning model (which may be obtained through a training process similar to the one described in FIG. 7). In this example, the NWDAF determines that VPN traffic through IPSec tunneling is happening and may store one or more of the following information:
Analytic-Type=IPSec
List of UE-IDs. This identifies which UE-IDs have been found to use tunneling (on a per tunneling protocol basis). Each UE-ID might include the subscriber identifier (SUPI/IMSI), the subscriber public identifier (PUI/MSISDN) and/or device identifier (PEI/IMEI). In this example (FIG. 10), the list of UE-IDs comprises a single UE-ID.
Indication of normal or abnormal scenario. In this case, the NWDAF determines that tunneled traffic (for the requested tunneling protocol) corresponds to normal scenario (e.g. VPN traffic), and optionally including a confidence level (e.g. a percentage from 0% to 100%).
List of App-IDs. Identifies the App-IDs generating the IPSec tunneling traffic. In this example of FIG. 10, App-ID=example.
List of Server IP addresses. Identifies the Server IP addresses (as tunnel endpoints). In this example of FIG. 10, a Server IP addresses comprises an IPSec tunnel endpoint.
Tunneled volume. This may for example comprise the percentage of tunneled traffic with respect to the total traffic volume. In this example of FIG. 10 the tunneled volume comprises tunneled IPSec volume as a percentage with respect to the total UE-ID session volume.
At least one recommended traffic management action, e.g. if the NWDAF determines that IPSec tunneled traffic corresponds to VPN scenario and most of the UE-ID session traffic is IPSec tunneled a recommended traffic management action may comprise slice re-selection, to move the user (and consequently its VPN traffic) into a separate slice (e.g. from MBB slice into a VPN slice). At least one recommended traffic management action may also comprise storing as subscriber data (for UE-ID) an indication of a subscriber/device where IPSec tunneling has been detected and the corresponding tunneling information.

In step 1023, the NWDAF notifies the Consumer NF (e.g. PCF) by transmitting a Nnwdaf_AnalyticsSubscription_Notify request message. The Nnwdaf_AnalyticsSubscription_Notify request message may comprise one or more of the following parameters:
Analytic-ID=Tunneling
Analytic-Type=IPSec
List of UE-IDs. This identifies which UE-IDs have been found to use tunneling (on a per tunneling protocol basis). Each UE-ID might include the subscriber identifier (SUPI/IMSI), the subscriber public identifier (PUI/MSISDN) and/or device identifier (PEI/IMEI). In this example (FIG. 5), a single UE-ID.
The AnalyticResult. This may comprise the information determined by the NWDAF in step 1022.

In step 1024, the consumer NF (e.g. PCF) answers the message in step 1023 with a successful response.

In step 1025, the consumer NF (e.g. PCF) initiates performance of the at least one recommended traffic management action based on the AnalyticResult, e.g. the consumer NF may request slice re-selection by moving the UE-ID session from existing slice (e.g. MBB) to another slice (Tunneling slice). In some examples, the consumer NF may indicate the reason for moving (e.g. VPN or IPSec tunneling), and the consumer NF may store tunneling information in the UDR.

In step 1026, the consumer NF (e.g. PCF) stores in the UDR an indication of a subscriber/device (e.g. the UE) where IPSec tunneling has been detected and the corresponding IPSec tunneling information. In order to do this, the consumer NR may transmit towards the UDR a Nudr_Store request message. The Nudr_Store request message comprises one or more of the following parameters:
UE-ID.
TunnelingInfo, including:
   Tunneling type=IPSec
   Indication of normal scenario (e.g. VPN), optionally including a confidence level (e.g. a percentage from 0% to 100%).
   List of App-IDs (in this example, App-ID=example).
   List of Server IPs (IPSec tunnel endpoint).

In step 1027, the UDR stores the TunnelingInfo in the subscriber data for UE-ID.

In step 1028, the UDR answers the message in step 1027 with a successful response.

Whilst it is not illustrated in FIG. 10, it will be appreciated that different recommended traffic management actions may be triggered by the consumer NF based on the AnalyticResult, e.g.:
The traffic for App-ID (example) may be charged (e.g. in a specific RG as VPN traffic).
The TunnelingInfo stored in the UDR may be used in subsequent sessions for UE-ID, e.g. to continue monitoring tunneling traffic for UE-ID and if the same behavior is found and/or if the accumulated tunneled volume exceeds a configured threshold, the user may be notified accordingly.

It will be appreciated that whilst in the above description the function of the NWDAF is described as being performed by a separate entity, the NWDAF may be co-located with another entity, such as the UPF.

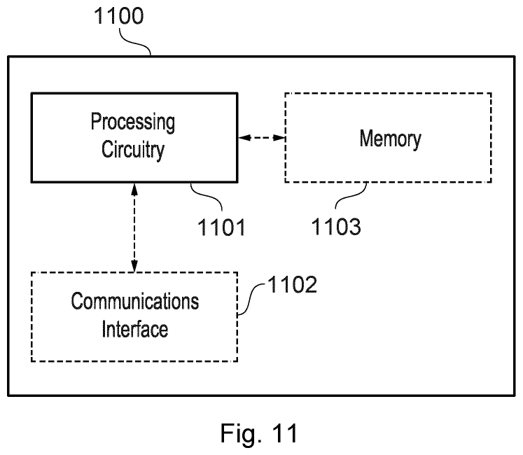

FIG. 11 illustrates a first network function (NF) 1100 comprising processing circuitry (or logic) 1101. The processing circuitry 1101 controls the operation of the first NF 1100 and can implement the method described herein in relation to a first NF 1100. The processing circuitry 1101 can comprise one or more processors, processing units, multi-core processors or modules that are configured or programmed to control the first NF 1100 in the manner described herein. In particular implementations, the processing circuitry 1101 can comprise a plurality of software and/or hardware modules that are each configured to perform, or are for performing, individual or multiple steps of the method described herein in relation to the first NF 1100.

Briefly, the processing circuitry 1101 of the first NF 1100 is configured to: receive a request from the consumer NF, to receive analytics relating to tunneling traffic; responsive to receiving the request, trigger one or more network nodes to transmit data relating to tunneling traffic to the first NF; receive data relating to tunneling traffic from one or more network nodes; analyse the received data to determine an analytic result; and transmit an indication of the analytic result to the consumer NF.

In some embodiments, the first NF 1100 may optionally comprise a communications interface 1102. The communications interface 1102 of the first NF 1100 can be for use in communicating with other nodes, such as other virtual nodes. For example, the communications interface 1102 of the first NF 1100 can be configured to transmit to and/or receive from other nodes requests, resources, information, data, signals, or similar. The processing circuitry 1101 of first NF 1100 may be configured to control the communications interface 1102 of the first NF 1100 to transmit to and/or receive from other nodes requests, resources, information, data, signals, or similar.

Optionally, the first NF 1100 may comprise a memory 1103. In some embodiments, the memory 1103 of the first NF 1100 can be configured to store program code that can be executed by the processing circuitry 1101 of the first NF 1100 to perform the method described herein in relation to the first NF 1100. Alternatively, or in addition, the memory 1103 of the first NF 1100, can be configured to store any requests, resources, information, data, signals, or similar that are described herein. The processing circuitry 1101 of the first NF 1100 may be configured to control the memory 1103 of the first NF 1100 to store any requests, resources, information, data, signals, or similar that are described herein.

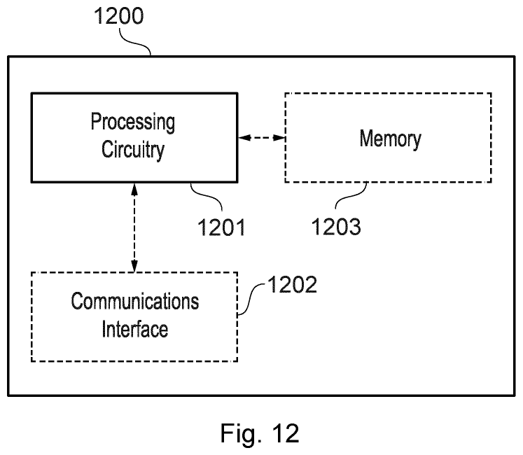

FIG. 12 illustrates a consumer network function (NF) 1200 comprising processing circuitry (or logic) 1201. The processing circuitry 1201 controls the operation of the consumer NF 1200 and can implement the method described herein in relation to a consumer NF 1200. The processing circuitry 1201 can comprise one or more processors, processing units, multi-core processors or modules that are configured or programmed to control the consumer NF 1200 in the manner described herein. In particular implementations, the processing circuitry 1201 can comprise a plurality of software and/or hardware modules that are each configured to perform, or are for performing, individual or multiple steps of the method described herein in relation to the consumer NF 1200.

Briefly, the processing circuitry 1201 of the consumer NF 1200 is configured to: transmit a request to the first NF, to receive analytics relating to tunneling traffic; and receive an indication of the analytic result from the first NF.

In some embodiments, the consumer NF 1200 may optionally comprise a communications interface 1202. The communications interface 1202 of the consumer NF 1200 can be for use in communicating with other nodes, such as other virtual nodes. For example, the communications interface 1202 of the consumer NF 1200 can be configured to transmit to and/or receive from other nodes requests, resources, information, data, signals, or similar. The processing circuitry 1201 of consumer NF 1200 may be configured to control the communications interface 1202 of the consumer NF 1200 to transmit to and/or receive from other nodes requests, resources, information, data, signals, or similar.

Optionally, the consumer NF 1200 may comprise a memory 1203. In some embodiments, the memory 1203 of the consumer NF 1200 can be configured to store program code that can be executed by the processing circuitry 1201 of the consumer NF 1200 to perform the method described herein in relation to the consumer NF 1200. Alternatively, or in addition, the memory 1203 of the consumer NF 1200, can be configured to store any requests, resources, information, data, signals, or similar that are described herein. The processing circuitry 1201 of the consumer NF 1200 may be configured to control the memory 1203 of the consumer NF 1200 to store any requests, resources, information, data, signals, or similar that are described herein.

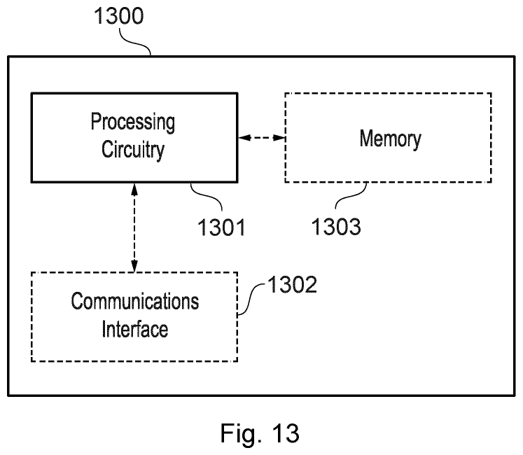

FIG. 13 illustrates a User Plane Function (UPF) 1300 comprising processing circuitry (or logic) 1301. The processing circuitry 1301 controls the operation of the UPF 1300 and can implement the method described herein in relation to a UPF 1300. The processing circuitry 1301 can comprise one or more processors, processing units, multi-core processors or modules that are configured or programmed to control the UPF 1300 in the manner described herein. In particular implementations, the processing circuitry 1301 can comprise a plurality of software and/or hardware modules that are each configured to perform, or are for performing, individual or multiple steps of the method described herein in relation to the UPF 1300.

Briefly, the processing circuitry 1301 of the UPF 1300 is configured to: receive a request from the first NF, to receive data relating to tunneling traffic; and responsive to detecting the tunneling traffic, provide data relating to the tunneling traffic to the first NF.

In some embodiments, the UPF 1300 may optionally comprise a communications interface 1302. The communications interface 1302 of the UPF 1300 can be for use in communicating with other nodes, such as other virtual nodes. For example, the communications interface 1302 of the UPF 1300 can be configured to transmit to and/or receive from other nodes requests, resources, information, data, signals, or similar. The processing circuitry 1301 of UPF 1300 may be configured to control the communications interface 1302 of the UPF 1300 to transmit to and/or receive from other nodes requests, resources, information, data, signals, or similar.

Optionally, the UPF 1300 may comprise a memory 1303. In some embodiments, the memory 1303 of the UPF 1300 can be configured to store program code that can be executed by the processing circuitry 1301 of the UPF 1300 to perform the method described herein in relation to the UPF 1300. Alternatively, or in addition, the memory 1303 of the UPF 1300, can be configured to store any requests, resources, information, data, signals, or similar that are described herein. The processing circuitry 1301 of the UPF 1300 may be configured to control the memory 1303 of the UPF 1300 to store any requests, resources, information, data, signals, or similar that are described herein.

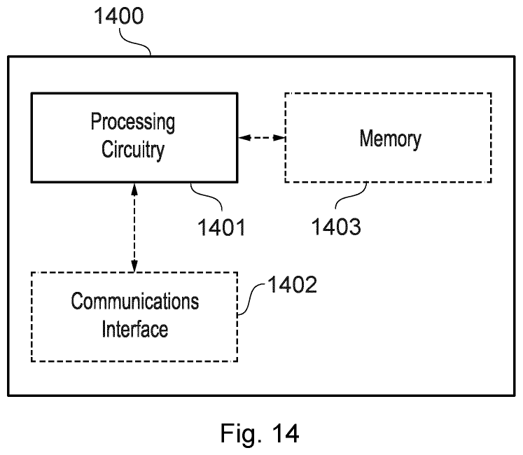

FIG. 14 illustrates a wireless device 1400 comprising processing circuitry (or logic) 1401. The processing circuitry 1401 controls the operation of the wireless device 1400 and can implement the method described herein in relation to a wireless device 1400. The processing circuitry 1401 can comprise one or more processors, processing units, multi-core processors or modules that are configured or programmed to control the wireless device 1400 in the manner described herein. In particular implementations, the processing circuitry 1401 can comprise a plurality of software and/or hardware modules that are each configured to perform, or are for performing, individual or multiple steps of the method described herein in relation to the wireless device 1400.

Briefly, the processing circuitry 1401 of the wireless device 1400 is configured to: receive a request from the first NF, wherein the request subscribes to receiving data relating to tunneling traffic; and responsive to detecting tunneling traffic, provide data relating to the tunneling traffic to the first NF.

In some embodiments, the wireless device 1400 may optionally comprise a communications interface 1402. The communications interface 1402 of the wireless device 1400 can be for use in communicating with other nodes, such as other virtual nodes. For example, the communications interface 1402 of the wireless device 1400 can be configured to transmit to and/or receive from other nodes requests, resources, information, data, signals, or similar. The processing circuitry 1401 of wireless device 1400 may be configured to control the communications interface 1402 of the wireless device 1400 to transmit to and/or receive from other nodes requests, resources, information, data, signals, or similar.

Optionally, the wireless device 1400 may comprise a memory 1403. In some embodiments, the memory 1403 of the wireless device 1400 can be configured to store program code that can be executed by the processing circuitry 1401 of the wireless device 1400 to perform the method described herein in relation to the wireless device 1400. Alternatively, or in addition, the memory 1403 of the wireless device 1400, can be configured to store any requests, resources, information, data, signals, or similar that are described herein. The processing circuitry 1401 of the wireless device 1400 may be configured to control the memory 1403 of the wireless device 1400 to store any requests, resources, information, data, signals, or similar that are described herein.

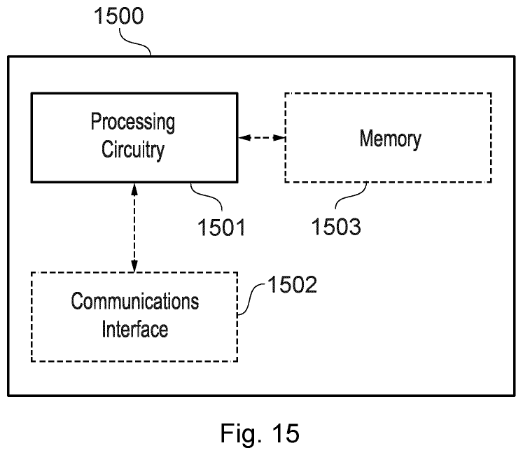

FIG. 15 illustrates a UDR 1500 comprising processing circuitry (or logic) 1501. The processing circuitry 1501 controls the operation of the UDR 1500 and can implement the method described herein in relation to a UDR 1500. The processing circuitry 1501 can comprise one or more processors, processing units, multi-core processors or modules that are configured or programmed to control the UDR 1500 in the manner described herein. In particular implementations, the processing circuitry 1501 can comprise a plurality of software and/or hardware modules that are each configured to perform, or are for performing, individual or multiple steps of the method described herein in relation to the UDR 1500.

Briefly, the processing circuitry 1501 of the UDR 1500 is configured to: receive a request from the first NF, for data relating to tunneling traffic, wherein the request comprises an indication of at least one wireless device identification; and provide tunneling related subscriber data associated with the at least one wireless device identification to the first NF.

In some embodiments, the UDR 1500 may optionally comprise a communications interface 1502. The communications interface 1502 of the UDR 1500 can be for use in communicating with other nodes, such as other virtual nodes. For example, the communications interface 1502 of the UDR 1500 can be configured to transmit to and/or receive from other nodes requests, resources, information, data, signals, or similar. The processing circuitry 1501 of UDR 1500 may be configured to control the communications interface 1502 of the UDR 1500 to transmit to and/or receive from other nodes requests, resources, information, data, signals, or similar.

Optionally, the UDR 1500 may comprise a memory 1503. In some embodiments, the memory 1503 of the UDR 1500 can be configured to store program code that can be executed by the processing circuitry 1501 of the UDR 1500 to perform the method described herein in relation to the UDR 1500. Alternatively, or in addition, the memory 1503 of the UDR 1500, can be configured to store any requests, resources, information, data, signals, or similar that are described herein. The processing circuitry 1501 of the UDR 1500 may be configured to control the memory 1503 of the UDR 1500 to store any requests, resources, information, data, signals, or similar that are described herein.

Embodiments described herein allow the network operator to support detection and control (e.g. traffic management, security attacks prevention, fraud prevention, etc) of different tunneling scenarios in a simple an efficient way, by identifying the amount and types of tunneled traffic in MNO's network, and which subscribers, devices, domains, applications and servers are responsible for it.

For example, if the tunneling traffic in MNO's network represents e.g. 15% of the total traffic (determined by the methods described above), this may be considered to be a significant amount, and gives a hint to MNO on the need to control this traffic (by taking actions). Additionally, from the 15% above, consider if IP in IP is 6%, GRE is 4%, IPSec is 3%. This (global) information may be useful for the MNO to take the corresponding decisions (e.g. to improve MNO's data service contract, allowing enterprises and/or individual subscribers to use VPNs within MNO's network, by creating a specific VPN bundle with an extra charge on top of the general Internet bundle). Additionally, the methods and apparatuses described above allow for identifying which subscribers use tunneling protocols in their sessions, so they can be offered accordingly on a per individual basis.

In another example, similarly to above the tunneling traffic represents 15% of the total traffic in MNO network, which is a significant amount, but in this example, by using the methods and apparatuses described above, it is determined that 13% of this traffic is from Enterprises, Industrial and/or IoT devices which connect by default to the Enterprise or Industrial network (through MNO's network) using tunneling protocols. In this example, individual subscribers' contribution to the total traffic is only 2%, which gives a hint to MNO not to take any specific action.

Embodiments described herein allows the MNO to detect tunneled traffic for VPNs, e.g. teleworkers, and the traffic management action might be e.g. moving teleworkers into a separate slice (i.e. separate from the MBB slice).

Embodiments described herein also allow the MNO to differentiate between “normal” tunneling scenarios (e.g. an MNO's subscriber doing teleworking) and malicious tunneling scenarios (e.g. fraud, security related attacks). For example, a teleworker would most probably have almost 100% of his/her traffic tunneled, while in a fraud/security scenario, the tunneled traffic would probably be a much smaller % (imagine tunneling only applies to a specific application, and the rest of traffic is regular traffic, not tunneled, for the rest of applications).

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-58. (canceled)

59. A method in a first network function (NF) in a network for providing, to a consumer NF, an analytic result relating to tunneling traffic, the method comprising:
receiving a request from the consumer NF, to receive analytics relating to tunneling traffic;
responsive to receiving the request, triggering one or more network nodes to transmit data relating to tunneling traffic to the first NF;
receiving data relating to tunneling traffic from one or more network nodes;
analyzing the received data to determine an analytic result; and
transmitting an indication of the analytic result to the consumer NF.

60. The method of claim 59, wherein the analytic result comprises an indication of detection of tunneling traffic.

61. The method of claim 59, wherein the analytic result comprises an indication of whether the tunneling traffic is considered normal or abnormal.

62. The method of claim 59, wherein analyzing the received data comprises utilizing a machine learning model to detect abnormal or normal tunneling traffic.

63. The method of claim 62, wherein the machine learning model is trained using tagged and/or untagged data relating to tunneling traffic collected from the one or more network nodes.

64. The method of claim 59, wherein analyzing the received data comprises analyzing one or more of: timestamp information, volume information, and flow information in the received data to detect abnormal or normal tunneling traffic.

65. The method of claim 59, wherein the analytic result comprises any one of a list of one or more application identifications that are generating the tunneling traffic, a list of one or more server addresses acting as tunnel endpoints for the tunneling traffic, a list of one or more target domains for the tunneling traffic, and/or an indication of at least one recommended traffic management action.

66. The method of claim 59, wherein the first network function comprises a Network Data Analytics Function (NWDAF).

67. A method, in a consumer network function for receiving an analytic result relating to tunneling traffic from a first network function (NF), the method comprising:
transmitting a request, to the first NF, to receive analytics relating to tunneling traffic; and
receiving an indication of an analytic result from the first NF.

68. The method of claim 67, wherein the analytic result comprises an indication of detection of tunneling traffic.

69. The method of claim 67, wherein the analytic result comprises an indication of whether the tunneling traffic is considered normal or abnormal.

70. The method of claim 67, wherein the request comprises an indication of a tunneling traffic type, and wherein the analytic result relates to the tunneling traffic of the tunneling traffic type.

71. The method of claim 67, wherein the request comprises a list of one or more wireless device identifications, and wherein the analytic result relates to tunneling traffic to or from one or more wireless devices identified by the wireless device identifications.

72. The method of claim 67, wherein the analytic result comprises any one of a list of one or more application identifications that are generating the tunneling traffic, a list of one or more server addresses acting as tunnel endpoints for the tunneling traffic, a list of one or more target domains for the tunneling traffic, and/or an indication of at least one recommended traffic management action.

73. A first network function (NF) in a network for providing, to a consumer NF, an analytic result relating to tunneling traffic, the first NF comprising processing circuitry and a memory, wherein the processing circuitry is configured to:
receive a request, from the consumer NF, to receive analytics relating to tunneling traffic;
responsive to receiving the request, trigger one or more network nodes to transmit data relating to tunneling traffic to the first NF;
receive data relating to tunneling traffic from one or more network nodes;
analyze the received data to determine an analytic result; and
transmit an indication of the analytic result to the consumer NF.

74. The first NF of claim 73, wherein the analytic result comprises an indication of detection of tunneling traffic.

75. The first NF of claim 73, wherein the analytic result comprises an indication of whether the tunneling traffic is considered normal or abnormal.

76. A consumer network function for receiving an analytic result relating to tunneling traffic from a first network function (NF) the consumer network function comprising processing circuitry and a memory wherein the processing circuitry is configured to:
transmit a request to the first NF, to receive analytics relating to tunneling traffic; and
receive an indication of the analytic result from the first NF.

77. The consumer network function of claim 76, wherein the analytic result comprises an indication of detection of tunneling traffic.

78. The consumer network function of claim 76, wherein the analytic result comprises an indication of whether the tunneling traffic is considered normal or abnormal.
